(19) United States
(12) Patent Application Publication
(10) Pub. No.: US 2026/0141573 A1
(43) Pub. Date: May 21, 2026

(54) MULTI-CONCEPT ADAPTOR LEARNING OF MULTI-MODAL LLM FOR IMAGE DIFFUSION MODEL

(71) Applicant: ADOBE INC., SAN JOSE, CA (US)

(72) Inventors: Yu-Jhe Li, Santa Clara, CA (US); Aashish Kumar Misraa, Santa Clara, CA (US); Midhun Harikumar, Sunnyvale, CA (US)

(21) Appl. No.: 18/953,734

(22) Filed: Nov. 20, 2024

(51) Int. Cl. G06T 11/00

(52) U.S. Cl. CPC G06T 11/00

(57) ABSTRACT

A method, apparatus, non-transitory computer readable medium, and system for image processing include obtaining an input image and a text prompt, wherein the input image depicts a first image element and the text prompt describes a second image element, generating a multimodal embedding based on the input image and the text prompt, wherein the multimodal embedding represents the first image element and the second image element in a multimodal embedding space, generating a guidance embedding based on the multimodal embedding, wherein the guidance embedding represents the first image element and the second image element in a guidance embedding space different from the multimodal embedding space, and generating a synthetic image based on the guidance embedding, wherein the synthetic image depicts the first image element and the second image element.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style.

In the field of image generation, an input prompt is provided to a machine learning model to generate a synthetic image. In some cases, the synthetic image depicts one or more elements described by the input prompt. In some cases, multiple input prompts with different modalities are input into the machine learning model. However, in some cases, conventional systems are unable to generate synthetic images depicting the elements described by the multiple input prompts due to the different modalities.

### SUMMARY

A method, apparatus, non-transitory computer readable medium, and system for image processing include obtaining an input image and a text prompt, where the input image depicts a first image element and the text prompt describes a second image element, generating a multimodal embedding based on the input image and the text prompt, where the multimodal embedding represents the first image element and the second image element in a multimodal embedding space, generating, using a mapping encoder, a guidance embedding based on the multimodal embedding, where the guidance embedding represents the first image element and the second image element in a guidance embedding space different from the multimodal embedding space, and generating, using an image generation model, a synthetic image based on the guidance embedding, where the synthetic image depicts the first image element and the second image element.

A method, apparatus, non-transitory computer readable medium, and system for image processing include obtaining an input image and a text prompt; generating a multimodal sequence of tokens based on the input image and the text prompt; generating, using a multimodal encoder, a multimodal embedding based on the multimodal sequence of tokens; generating, using a mapping encoder, a guidance embedding based on the multimodal embedding; and generating, using an image generation model, a synthetic image based on the guidance embedding

A method, apparatus, non-transitory computer readable medium, and system for training a machine learning model include obtaining a training set including an image and a text prompt describing the image, generating a multimodal embedding based on the text prompt, generating, using an image generation model, a synthetic image based on the multimodal embedding, and training, using the training set and the synthetic image, a mapping encoder to generate a guidance embedding for the image generation model.

An apparatus and system for image processing include at least one memory component, at least one processing device coupled to the memory component, a mapping encoder comprising parameters stored in the memory component trained to generate a guidance embedding based on a multimodal embedding, where the guidance embedding represents a first image element from an input image and a second image element from a text prompt in a guidance embedding space, and an image generation model comprising parameters stored in the memory component trained to generate a synthetic image based on the guidance embedding, where the synthetic image depicts the first image element and the second image element.

### BRIEF DESCRIPTION OF THE DRAWINGS

FIG. 1 shows an example of an image processing system according to aspects of the present disclosure.

FIG. 2 shows an example of a method for conditional image generation according to aspects of the present disclosure.

FIG. 3 shows an example of text-to-image generation according to aspects of the present disclosure.

FIG. 4 shows an example of image-to-image generation according to aspects of the present disclosure.

FIG. 5 shows an example of text-image pair to image generation according to aspects of the present disclosure.

FIG. 6 shows an example of text-image set to image generation according to aspects of the present disclosure.

FIG. 7 shows an example of a method for generating a synthetic image based on a text prompt and an input image according to aspects of the present disclosure.

FIG. 8 shows an example of an image processing apparatus according to aspects of the present disclosure.

FIG. 9 shows an example of a machine learning model according to aspects of the present disclosure.

FIG. 10 shows an example of an image generation model according to aspects of the present disclosure.

FIG. 11 shows an example of a U-Net architecture according to aspects of the present disclosure.

FIG. 12 shows an example of a diffusion process according to aspects of the present disclosure.

FIG. 13 shows an example of a method for combining the image token and the text token according to aspects of the present disclosure.

FIG. 14 shows an example of a method for training a machine learning model according to aspects of the present disclosure.

FIG. 15 shows an example of a first training stage according to aspects of the present disclosure.

FIG. 16 shows an example of a second training stage according to aspects of the present disclosure.

FIG. 17 shows an example of a flow diagram depicting an algorithm as a step-by-step procedure in an example implementation of operations performable for training a machine learning model according to aspects of the present disclosure.

FIG. 18 shows an example of a method for training a diffusion model according to aspects of the present disclosure.

FIG. 19 shows an example of a computing device according to aspects of the present disclosure.

### DETAILED DESCRIPTION

The following relates to image generation using generative machine learning. Embodiments of the disclosure relate to an image generation system that accurately generates a synthetic image based on one or more inputs having different modalities. In one aspect, the system includes a multimodal encoder (e.g., a multimodal language generation model) configured to generate a multimodal embedding in a joint embedding space (e.g., a multimodal embedding space) based on a text prompt and an input image. The system further includes a mapping encoder trained to convert the multimodal embedding into a guidance embedding in a guidance embedding space (e.g., a text embedding or image embedding space). By using the guidance embedding to guide the image generation process, the system ensures accurate image content generation that accurately depicts the image elements from one or more inputs having the same or different modalities.

According to some embodiments, the system includes a multimodal encoder configured to encode the inputs having the same or different modalities into a joint embedding space. For example, the inputs may include a text prompt and an input image. In some aspects, the multimodal encoder includes a text tokenizer (or text encoder) and an image tokenizer (or image encoder). In some cases, the image tokenizer is configured to tokenize the input image to generate a first token (e.g., an image token). In some cases, the text tokenizer is configured to tokenize the text prompt to generate a text token. In some embodiments, the multimodal encoder combines the tokens by arranging the text token and the image token in a way that captures the semantic meaning, correlation, and relation between the text prompt and the input image. In one aspect, the multimodal encoder generates a multimodal embedding based on the combined tokens.

According to some embodiments, the system includes a mapping encoder trained to generate a guidance embedding based on the multimodal embedding. For example, the multimodal embedding represents the image elements of the inputs in a multimodal embedding space (e.g., a joint embedding space). In some cases, the mapping encoder converts the multimodal embedding in the joint embedding space to a guidance embedding in a guidance embedding space for the image generation model. In some cases, the guidance embedding space may be a text embedding space, an image embedding space, or a combination thereof (e.g., a multimodal embedding space). By using the guidance embedding as guidance to the image generation model, the image generation model of the system can accurately generate a synthetic image depicting the image elements from the one or more inputs from different modalities. By training the mapping encoder to generate the guidance embedding, the guidance embedding can be used to augment the pretrained image generation model to accurately generate the synthetic.

A subfield in image processing relates to multimodal image generation. For example, conventional image generation systems receive multimodal inputs such as a text prompt and an input image to generate an output image depicting elements from the multimodal inputs. In some cases, these systems are intended to generate images that are closely aligned with the inputs. In some cases, an objective of these systems is to ensure that the generated images are relevant to the inputs. However, in some cases, these systems fail to understand the semantic meaning, correlation, and relation between the multimodal inputs, and thus fail to generate a coherent synthetic image that depicts the elements from the inputs.

Some conventional systems combine discrete visual elements into a cohesive image. However, these systems often face challenges with seamless integration. When stitching objects together, mismatches in lighting, perspective, or style can occur, resulting in unnatural compositions that break the visual harmony of the scene. In some cases, when different objects interact in a meaningful way, such as a person holding an item, unnatural artifacts are generated. These systems are less effective for complex image generation tasks that require a high degree of realism and interaction between multiple elements.

Some conventional image generation systems involve an image inpainting task, which fills in missing or removed parts of an image by generating new content or image pixels based on the surrounding image pixels. In some cases, these systems perform well in restoring incomplete images, however, these systems struggle in multi-concept scenarios where new objects or concepts are introduced that were not part of the original image. For example, the inpainting technique fails to generate contextually coherent content, leading to visual artifacts or inconsistencies. Image inpainting technique is primarily trained to complete an image rather than generating new elements that adhere to a complex description involving multiple interacting objects or modalities.

Some conventional systems involve image composition with masks which enables the systems for more control where one or more objects are placed in an image by using predetermined regions. Although useful for controlled compositions, this technique lacks flexibility in dynamic and multi-concept scenarios. In some cases, mask-based composition systems require predetermined layouts and might not dynamically adapt to complex descriptions that involve intricate spatial relationships between multiple objects or modalities. The reliance on manual intervention and rigid structures further limits the scalability and generalization of these methods and systems. As a result, these systems are inadequate for tasks that require high levels of creative and automated multi-modal image generation.

Embodiments of the disclosure improve on conventional image generation models by generating a synthetic image more accurately based on multimodal inputs (e.g., a text prompt and an input image). This is achieved using a system that includes a multimodal encoder, a mapping encoder, and an image generation model. In one aspect, the multimodal encoder is configured to generate a multimodal embedding that accurately represents the semantic meaning, correlation, and relation of the image elements from the multimodal inputs. In one aspect, the mapping encoder is trained to generate a guidance embedding based on the multimodal embedding, where the guidance embedding is represented in a guidance embedding space that can be processed by an image generation model (e.g., a pretrained image generation model guided based on a text embedding, an image embedding, or a multimodal embedding). The guidance embedding generated from the mapping encoder is provided to the image generation model to guide the image generation process to accurately generate a synthetic image that depicts image elements from one or more inputs having different modalities in a coherent way.

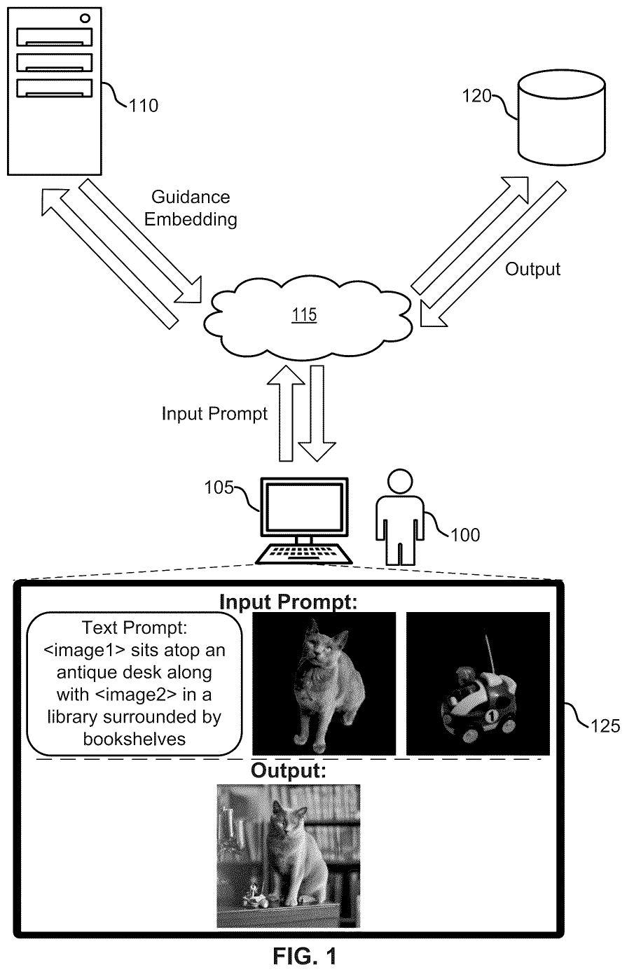

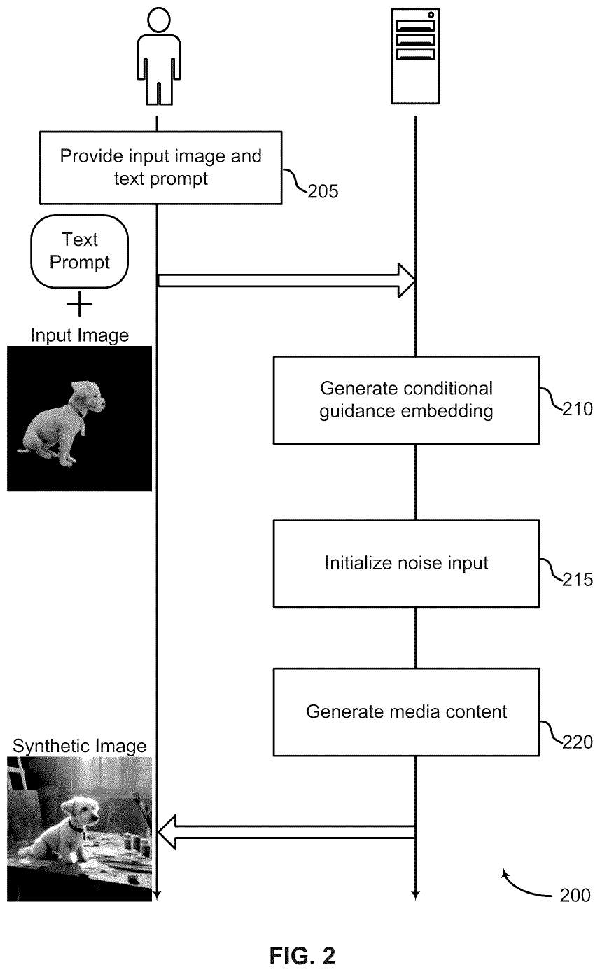

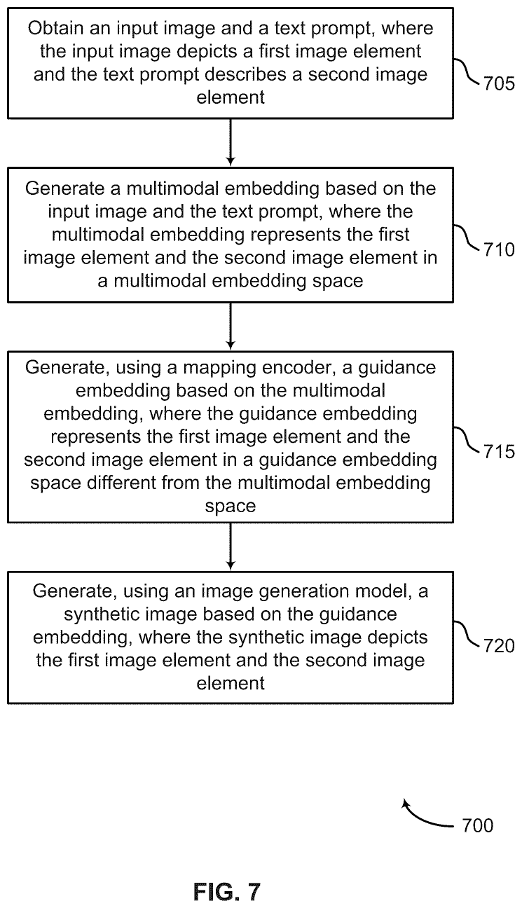

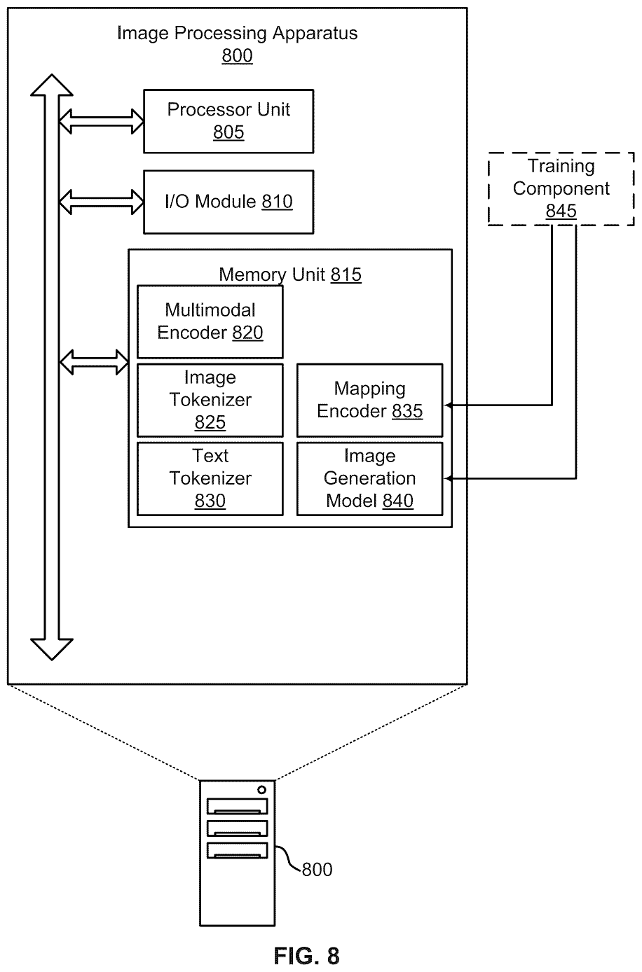

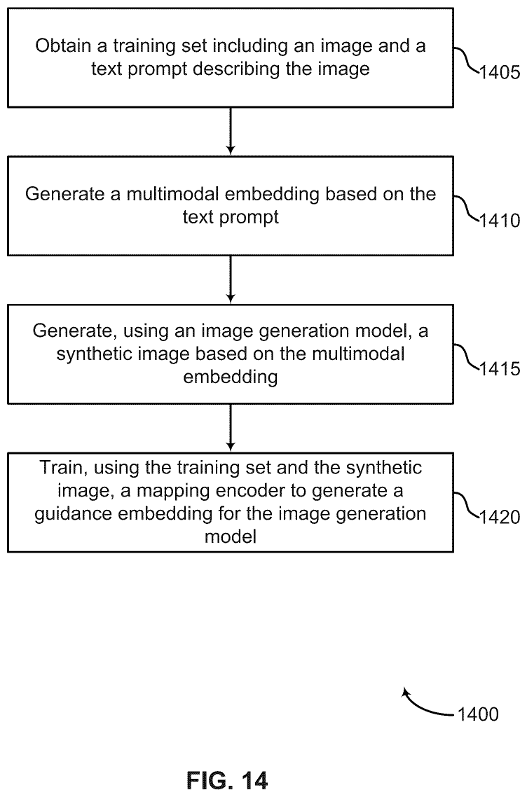

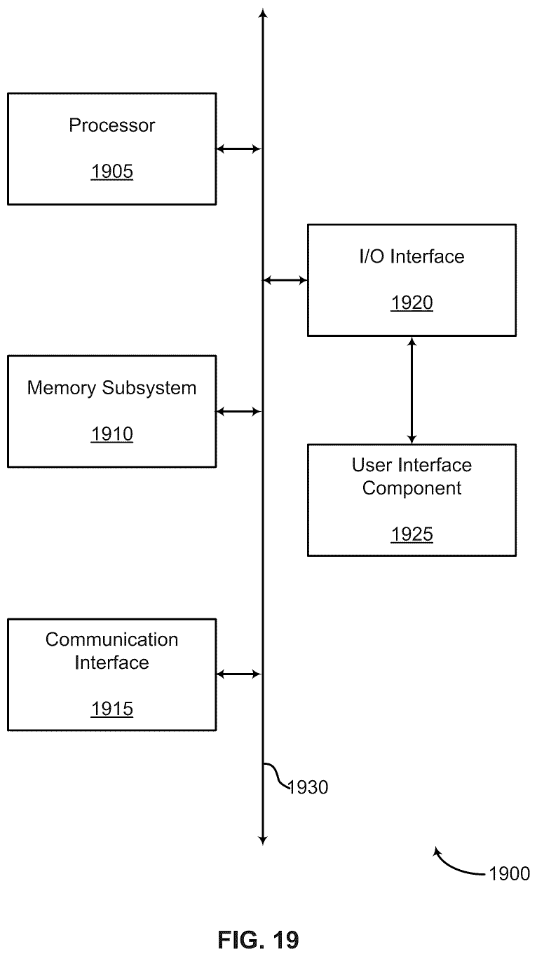

An example system of the present disclosure in image processing is provided with reference to FIGS. 1 and 19. An example application of the present disclosure in image processing is provided with reference to FIGS. 2-6. Details regarding the architecture of an image processing apparatus are provided with reference to FIGS. 8-11. An example of a process for image processing is provided with reference to FIGS. 7 and 12-13. A description of an example training process is provided with reference to FIGS. 14-18.

Accordingly, the present disclosure provides a system and method that improve on conventional image generation systems by accurately generating a synthetic image depicting image elements from one or more inputs having different modalities. By combining the text token of the text prompt and the image token of the input image in a multimodal embedding space, the system can understand the semantic meaning, correlation, and relation between the text prompt and the input image to generate the multimodal embedding. By converting the multimodal embedding to the guidance embedding, the system can efficiently and effectively guide the image generation process of the image generation model. By reducing the complexity of the training dataset, the system is more efficient and practical for real-world applications compared to conventional systems. In some aspects, the mapping encoder can be used to augment pretrained image generation models, enabling these models to take multimodal inputs to generate a synthetic image. The two-stage training method and use of diffusion loss ensure that the generated images have increased image quality and aligns with the multimodal input conditions.

### Multimodal Image Generation

In FIGS. 1-7 and 12-13, a method, apparatus, non-transitory computer readable medium, and system for image processing include obtaining an input image and a text prompt, where the input image depicts a first image element and the text prompt describes a second image element, generating a multimodal embedding based on the input image and the text prompt, where the multimodal embedding represents the first image element and the second image element in a multimodal embedding space, generating, using a mapping encoder, a guidance embedding based on the multimodal embedding, where the guidance embedding represents the first image element and the second image element in a guidance embedding space different from the multimodal embedding space, and generating, using an image generation model, a synthetic image based on the guidance embedding, where the synthetic image depicts the first image element and the second image element.

Some examples of the method, apparatus, non-transitory computer readable medium, and system further include tokenizing the input image to obtain a first token representing the first image element. Some examples further include tokenizing the text prompt to obtain a second token representing the first image element. Some examples further include generating a multimodal sequence of tokens including the first token and the second token, where the multimodal embedding is generated based on the multimodal sequence of tokens. Some examples of the method, apparatus, non-transitory computer readable medium, and system further include replacing a nonce token from the text prompt with the first token.

Some examples of the method, apparatus, non-transitory computer readable medium, and system further include obtaining an additional image depicting a third image element, where the multimodal embedding includes a third token representing the third image element and the synthetic image depicts the third image element. Some examples of the method, apparatus, non-transitory computer readable medium, and system further include providing the input image to the image generation model to preserve an identity of the first image element in the synthetic image.

Some examples of the method, apparatus, non-transitory computer readable medium, and system further include obtaining a noise input. Some examples further include denoising the noise input based on the guidance embedding to generate the synthetic image. In some aspects, the mapping encoder is trained to generate the guidance embedding while the image generation model is frozen. In some aspects, the image generation model is trained jointly with the mapping encoder.

FIG. 1 shows an example of an image processing system according to aspects of the present disclosure. The example shown includes user 100, user device 105, image processing apparatus 110, cloud 115, database 120, and display device 125. In one aspect, user device 105 includes display device 125. Image processing apparatus 110 is an example of, or includes aspects of, the corresponding element described with reference to FIG. 8.

Referring to FIG. 1, user 100 provides input prompts to image processing apparatus 110 via display device 125 of user device 105 through cloud 115 to generate an output. In some cases, for example, the input prompt includes a text prompt, a first input image, and a second input image. In some cases, the text prompt includes a nonce token indicating a position of the object depicted in the input image(s). For example, the text prompt states “A cat sits atop an antique desk along with a toy car in a library surrounded by bookshelves.” In some cases, the text prompt replaces the object with nonce tokens. For example, the text prompt may state “<image1> sits atop an antique desk along with <image2> in a library surrounded by bookshelves.” For example, the nonce token <image1> represents the cat depicted in the first input image and the nonce token <image2> represents the toy car depicted in the second input image. In some cases, the text prompt including the nonce token is generated by the system and is provided to the image processing apparatus 110.

In some aspects, the image processing apparatus 110 includes a machine learning model that processes the input prompts and generates the output (e.g., the synthetic image). For example, the machine learning model includes a multimodal encoder configured to encode the input prompts to generate a multimodal embedding. Then, a mapping encoder is used to convert the multimodal embedding in the joint embedding space to a guidance embedding in a guidance embedding space. In some aspects, the machine learning model includes an image generation model configured to take the guidance embedding to guide the image generation process to generate the synthetic image. In one aspect, the synthetic image depicts the image elements (e.g., the cat, toy car, and library with bookshelves) from the input prompts. Image processing apparatus 110 displays the synthetic image via display device 125 of the user device 105 to user 100 via cloud 115.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110. In some cases, user device 105 may include a user interface that performs functions of the image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 8. According to some aspects, image processing apparatus 110 includes a computer implemented network comprising a machine learning model, a language generation model, an image generation model, and a storyboard component. Image processing apparatus 110 further includes a processor unit, a memory unit, an I/O module, a user interface, and a training component. In some embodiments, image processing apparatus 110 further includes a communication interface, user interface components, and a bus as described with reference to FIG. 19. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data including an image and a text prompt describing the image. In some aspects, database 120 stores output generated from the image processing apparatus 110. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for conditional image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides an input image and a text prompt. In some cases, the operations of this step refer to, or may be performed by, a user as described with reference to FIG. 1. In some cases, the user provides the input image and the text prompt to the multimodal encoder of the system. For example, the text prompt may state “A dog lies amidst a creative chaos on a stained worktable in an artist's atelier.” For example, the input image depicts the dog. In some cases, the input image is in a pixel space (e.g., an image space) and the text prompt is in a text space.

In one aspect, the multimodal encoder includes a text tokenizer configured to tokenize the text prompt to generate a text token. In one aspect, the multimodal encoder includes an image tokenizer configured to tokenize the input image to generate an image token. The image token and the text token are combined and input into the multimodal encoder to generate a multimodal embedding representing the elements from the input image and the text prompt in a joint embedding space.

At operation 210, the system generates conditional guidance embedding. In some cases, the operations of this step refer to, or may be performed by, an image processing apparatus as described with reference to FIGS. 1 and 8. In some cases, the operations of this step refer to, or may be performed by, a mapping encoder as described with reference to FIGS. 8, 9, 15, and 16. In some cases, the mapping encoder is trained to receive the multimodal embedding in the joint embedding space (generated from the multimodal encoder) to generate a guidance embedding in a guidance embedding space (e.g., a text embedding space, image embedding space, or a multimodal embedding space). In some cases, the guidance embedding is used as input to an image generation model to guide the image generation process.

At operation 215, the system initializes noise input. In some cases, the operations of this step refer to, or may be performed by, an image processing apparatus as described with reference to FIGS. 1 and 8. In some cases, the operations of this step refer to, or may be performed by, an image generation model as described with reference to FIGS. 8, 9, 15, and 16. In some cases, the noise input including random noise is initialized. The noise input may be in a latent space. By initializing the image generation model with random noise, different variations of a synthetic image including the content described by the text conditioning (e.g., the text prompt and the input image) can be generated.

At operation 220, the system generates media content. In some cases, the operations of this step refer to, or may be performed by, an image processing apparatus as described with reference to FIGS. 1 and 8. In some cases, the operations of this step refer to, or may be performed by, an image generation model as described with reference to FIGS. 8, 9, 15, and 16. In some cases, the media content includes a synthetic image. In some aspects, the image generation model performs a denoising process (e.g., a reverse diffusion process) to denoise the noise input. During the denoising process, the guidance embedding (generated by the mapping encoder) is used to guide the denoise process. Accordingly, the image generation model generates a synthetic image that aligns with the guidance embedding. For example, the synthetic image depicts the dog sitting on a stained worktable. In some cases, the synthetic image is displayed to a user as described with reference to FIG. 1.

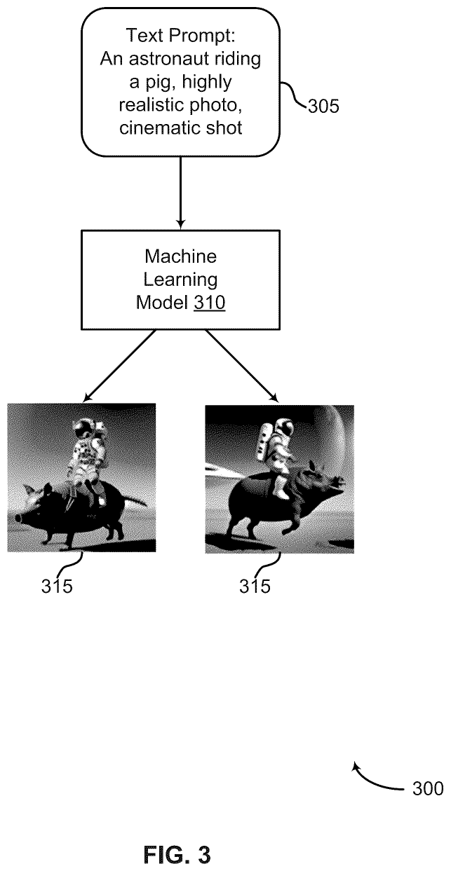

FIG. 3 shows an example of text-to-image generation according to aspects of the present disclosure. The example shown includes image generation system 300, text prompt 305, machine learning model 310, and synthetic image 315. In some embodiments, the image generation system 300 is implemented in a user interface.

Referring to FIG. 3, the image generation system 300 receives a text prompt 305 and generates a synthetic image 315. For example, the text prompt 305 states “An astronaut riding a pig, highly realistic photo, cinematic shot.” In some aspects, the machine learning model 310 includes a multimodal encoder, a mapping encoder, and an image generation model. For example, the multimodal encoder receives the text prompt 305 and generates a multimodal embedding representing one or more image elements described by the text prompt 305. Then, the mapping encoder generates a guidance embedding based on the multimodal embedding. In some cases, the guidance embedding is in a guidance embedding space different from the joint embedding space that the multimodal embedding is in. In some embodiments, the guidance embedding is provided to the image generation model to guide the image generation process to generate the synthetic image 315 depicting the image element(s) described by the text prompt 305. In some embodiments, by initializing the image generation model with random noise, variations of the synthetic image 315 can be generated.

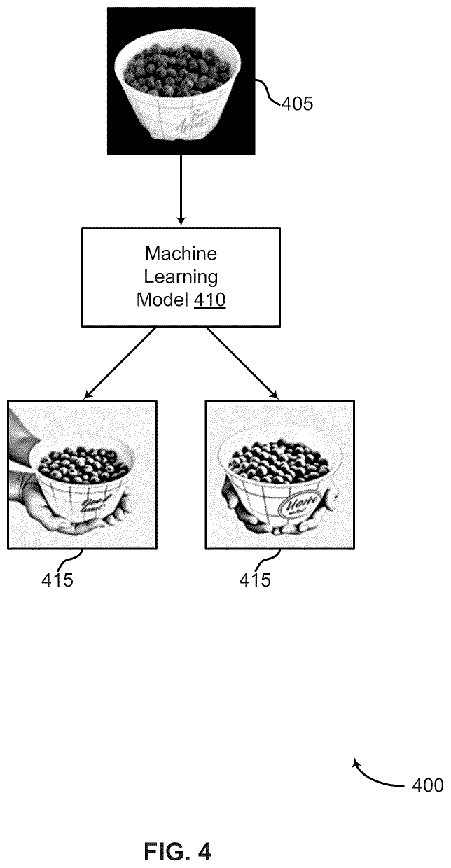

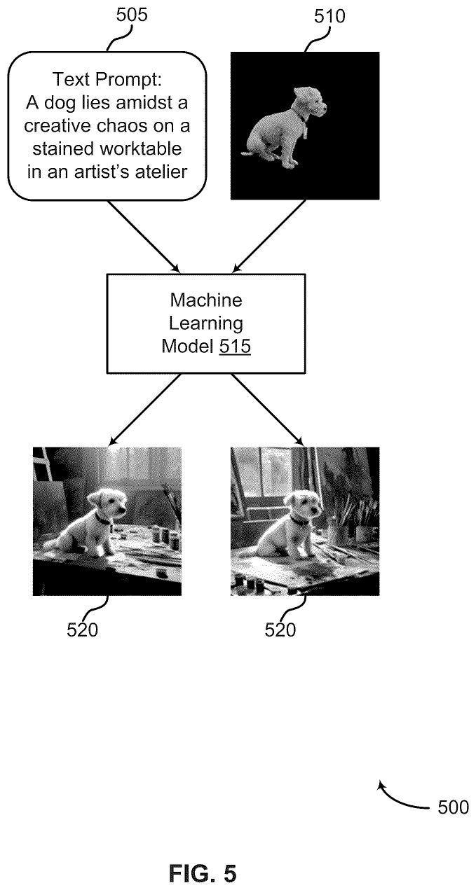

Image generation system 300 is an example of, or includes aspects of, the corresponding element described with reference to FIGS. 4-6. Text prompt 305 is an example of, or includes aspects of, the corresponding element described with reference to FIGS. 5, 6, 9, 10, 15, and 16. Machine learning model 310 is an example of, or includes aspects of, the corresponding element described with reference to FIGS. 4-6. Synthetic image 315 is an example of, or includes aspects of, the corresponding element described with reference to FIGS. 4-6, and 9.

FIG. 4 shows an example of image-to-image generation according to aspects of the present disclosure. The example shown includes image generation system 400, input image 405, machine learning model 410, and synthetic image 415. In some embodiments, the image generation system 400 is implemented in a user interface.

Referring to FIG. 4, the image generation system 400 receives an input image 405 and generates a synthetic image 415. For example, the input image 405 depicts a bowl of blueberries. In some aspects, the machine learning model 410 includes a multimodal encoder, a mapping encoder, and an image generation model. For example, the multimodal encoder receives the input image 405 and generates a multimodal embedding representing one or more image elements described by the input image 405. Then, the mapping encoder generates a guidance embedding based on the multimodal embedding. In some cases, the guidance embedding is in a guidance embedding space different from the joint embedding space that the multimodal embedding is in. In some embodiments, the guidance embedding is provided to the image generation model to guide the image generation process to generate the synthetic image 415 depicting the image element(s) depicted in the input image 405 with a different style. For example, the style may be a pair of hands holding the bowl of blueberries. In some cases, the style may be indicated by a style prompt (e.g., a reference image depicting the style) or a text description describing the style. In some embodiments, by initializing the image generation model with random noise, variations of the synthetic image 415 can be generated.

Image generation system 400 is an example of, or includes aspects of, the corresponding element described with reference to FIGS. 3, 5, and 6. Input image 405 is an example of, or includes aspects of, the corresponding element described with reference to FIGS. 5, 9, and 16. Machine learning model 410 is an example of, or includes aspects of, the corresponding element described with reference to FIGS. 3, 5, and 6. Synthetic image 415 is an example of, or includes aspects of, the corresponding element described with reference to FIGS. 3, 5, 6, and 9.

FIG. 5 shows an example of text-image pair to image generation according to aspects of the present disclosure. The example shown includes image generation system 500, text prompt 505, input image 510, machine learning model 515, and synthetic image 520. In some embodiments, the image generation system 500 is implemented in a user interface.

Referring to FIG. 5, the image generation system 500 receives a text prompt 505 and input image 510, and generates a synthetic image 520. For example, the text prompt 505 states “A dog lies amidst a creative chaos on a stained worktable in an artist's atelier.” For example, the input image 510 depicts the dog. In some aspects, the machine learning model 515 includes a multimodal encoder, a mapping encoder, and an image generation model. For example, the multimodal encoder receives the text prompt 505 and generates a text token (e.g., a second token) representing one or more image elements described by the text prompt 505. For example, the multimodal encoder receives the input image 510 and generates an image token (e.g., a first token) representing one or more image elements depicted by the input image 510.

According to some aspects, the multimodal encoder combines the text token and the image token, and generates multimodal embedding representing image elements from the inputs (e.g., the text prompt 505 and the input image 510). Then, the mapping encoder generates a guidance embedding based on the multimodal embedding. In some cases, the guidance embedding is in a guidance embedding space different from the joint embedding space that the multimodal embedding is in. In some embodiments, the guidance embedding is provided to the image generation model to guide the image generation process to generate the synthetic image 520 depicting the image elements. In some embodiments, by initializing the image generation model with random noise, variations of the synthetic image 520 can be generated.

Image generation system 500 is an example of, or includes aspects of, the corresponding element described with reference to FIGS. 3, 4, and 6. Text prompt 505 is an example of, or includes aspects of, the corresponding element described with reference to FIGS. 3, 6, 9, 10, 15, and 16. Input image 510 is an example of, or includes aspects of, the corresponding element described with reference to FIGS. 4, 9, and 16.

Machine learning model 515 is an example of, or includes aspects of, the corresponding element described with reference to FIGS. 3, 4, and 6. Synthetic image 520 is an example of, or includes aspects of, the corresponding element described with reference to FIGS. 3, 4, 6, and 9.

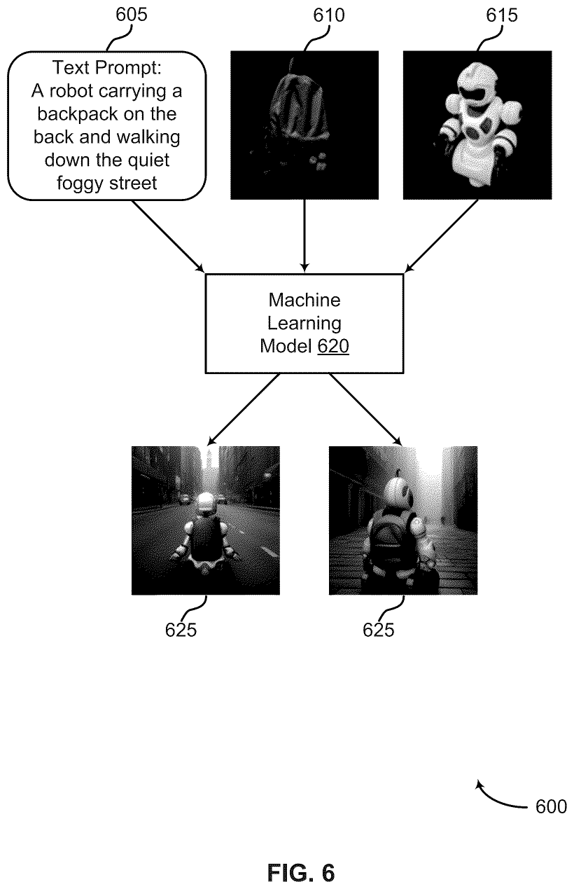

FIG. 6 shows an example of text-image set to image generation according to aspects of the present disclosure. The example shown includes image generation system 600, text prompt 605, first input image 610, second input image 615, machine learning model 620, and synthetic image 625. In some embodiments, the image generation system 600 is implemented in a user interface.

Referring to FIG. 6, the image generation system 600 receives a text prompt 605 a first input image 610, and a second input image 615, and generates a synthetic image 625. For example, the text prompt 605 states “A robot carrying a backpack on the back and walking down the quiet foggy street.” For example, the first input image 610 depicts the backpack. For example, the second input image 615 depicts the robot. In some aspects, the machine learning model 620 includes a multimodal encoder, a mapping encoder, and an image generation model. For example, the multimodal encoder receives the text prompt 605 and generates a text token (e.g., a second token) representing one or more image elements described by the text prompt 605. For example, the multimodal encoder receives the first input image 610 and generates an image token (e.g., a first token) representing one or more image elements depicted by the first input image 610. In some cases, the multimodal encoder receives the first input image 610 and generates a second image token (e.g., the third token) representing one or more image elements depicted by the second input image 615.

According to some aspects, the multimodal encoder combines the text token and the image tokens, and generates multimodal embedding representing image elements from the inputs (e.g., the text prompt 605, the first input image 610, and the second input image 615). In some cases, the text token and the image tokens are arranged in a way that enables the machine learning model 620 to understand the semantic meaning, correlation, and relation between the multimodal inputs (e.g., the text prompt 605, the first input image 610, and the second input image 615). Then, the mapping encoder generates a guidance embedding based on the multimodal embedding. In some cases, the guidance embedding is in a guidance embedding space different from the joint embedding space that the multimodal embedding is in. In some embodiments, the guidance embedding is provided to the image generation model to guide the image generation process to generate the synthetic image 625 depicting the image elements. In some embodiments, by initializing the image generation model with random noise, variations of the synthetic image 625 can be generated.

According to some embodiments, the machine learning model 620 is trained to perform image generation based on multimodal inputs (e.g., multiple images and a text prompt as inputs). In some cases, the machine learning model 620 is trained to perform multiple-object insertion. For example, an input text prompt (e.g., the text prompt 605) provides a detailed description of the image elements to be generated in a synthetic image. For example, the input text prompt may describe a relationship between the input images and a scene of the synthetic image. For example, the input text prompt may describe configurations of the object depicted in the input images. In some cases, the machine learning model 620 generates the synthetic image 625 depicting the image elements (or object) depicted in the input images (e.g., the first input image 610 and the second input image 615) in a scene or composition described by the input text prompt. In some cases, the configurations of the objects depicted in the input images may be substantially the same as the configurations of the objects depicted in the synthetic image 625. In some cases, the two objects depicted in the input images can be combined in the synthetic image 625 with the text prompt 605 to guide the image variation.

According to some embodiments, the machine learning model 620 is trained to perform multiple-concept fusion. For example, as shown in FIG. 6, the machine learning model 620 generates the synthetic image 625 that includes the image elements (e.g., the backpack and the robot) depicted in the input images (e.g., the first input image 610 and the second input image 615) with a configuration different than the configurations shown in the input images. For example, the configuration of the image elements (e.g., the objects) aligns with the configuration described by the text prompt 605.

Image generation system 600 is an example of, or includes aspects of, the corresponding element described with reference to FIGS. 3-5. Text prompt 605 is an example of, or includes aspects of, the corresponding element described with reference to FIGS. 3, 6, 9, 10, 15, and 16. Machine learning model 620 is an example of, or includes aspects of, the corresponding element described with reference to FIGS. 3-5. Synthetic image 625 is an example of, or includes aspects of, the corresponding element described with reference to FIGS. 3-5, and 9.

FIG. 7 shows an example of a method 700 for generating a synthetic image based on a text prompt and an input image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains an input image and a text prompt, where the input image depicts a first image element and the text prompt describes a second image element. In some cases, the operations of this step refer to, or may be performed by, a multimodal encoder as described with reference to FIGS. 8, 9, 15, and 16. For example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof. In some cases, for example, an image element may indicate a configuration, a style, a color scheme, a lighting effect, a perspective, a view angle, a texture, or a composition rule of an image.

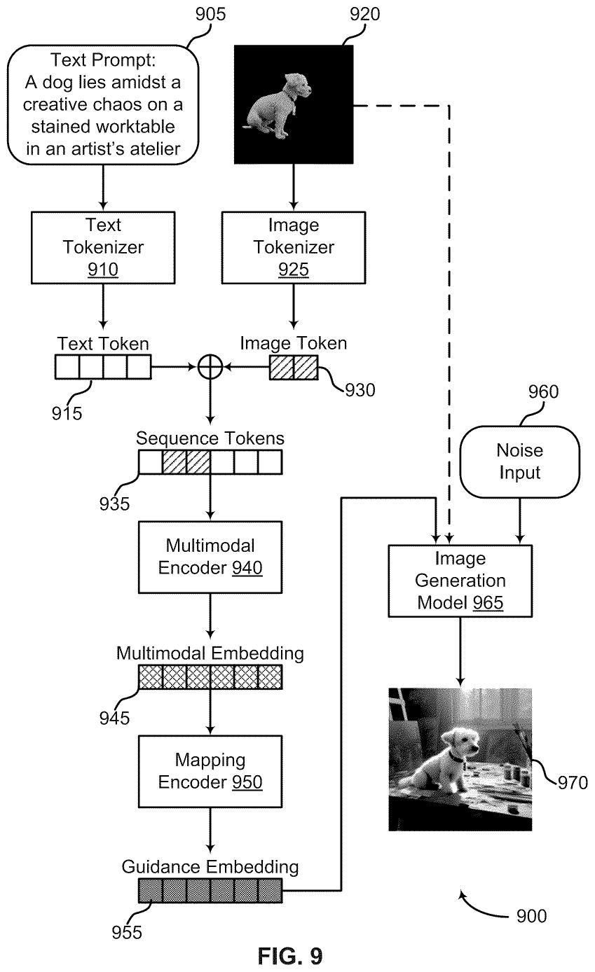

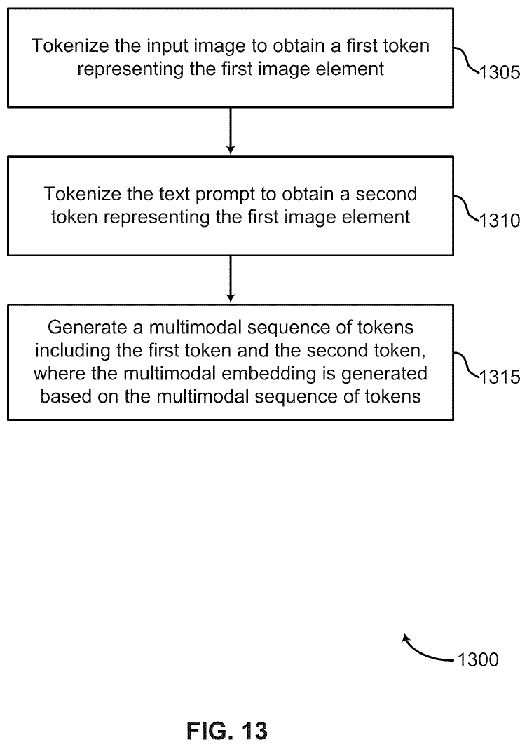

At operation 710, the system generates a multimodal embedding based on the input image and the text prompt, where the multimodal embedding represents the first image element and the second image element in a multimodal embedding space. In some cases, the operations of this step refer to, or may be performed by, a multimodal encoder as described with reference to FIGS. 8, 9, 15, and 16. In some cases, the system tokenizes the input image to generate an image token (e.g., the first token) and tokenizes the text prompt to generate a text token (e.g., the second token). In some cases, the image token and the text token are combined to generate a multimodal sequence of tokens representing the semantic meaning, correlation, and relation of the text prompt and the input image. In some aspects, the multimodal embedding is generated based on the multimodal sequence of tokens. Further detail on generating the multimodal sequence of tokens is described with reference to FIGS. 9 and 13.

In some cases, for example, an image is divided into smaller parts such as patches or image tokens. An image token is a numerical representation of small segments of the image, such as pixels or groups of pixels, which can be processed by a computing device (e.g., a machine learning model or a computer algorithm). In some cases, a text prompt is broken down into individual units such as words, sub-words, or characters. For example, a text token may represent a word in a sentence, group of words in a sentence, sub-words in a sentence, or individual characters in a sentence. In some cases, the multimodal sequence of tokens can be represented as a string including a set of words/letters (representing the text tokens of the text prompt) and numeric values (representing the image token of the input image).

In some embodiments, the system generates a text embedding based on the text prompt. In some cases, a text embedding is a numerical vector that captures the semantic meaning of the text, encoding words, phrases, or sentences into a dense, continuous space. For example, the text embedding is encoded into a text embedding space, which is a low-dimensional vector space. The text embedding is generated by passing the text prompt through an encoder (e.g., a text encoder or multi-modal encoder) that learns the relationships between words based on the context within large corpora of text. In some cases, the text embedding represents textual features (e.g., the semantic meaning, relationship between words, or lexical features) of the text prompt.

In some embodiments, the system generates an image embedding based on the input image. For example, the image embedding is a numerical (or vector) representation of an image in a high-dimensional vector space. For example, image embedding captures the essential visual features or visual characteristics of an image, such as color, texture, shape, and spatial relationships.

In some cases, a text embedding space is a continuous, low-dimensional vector space where each vector represents the semantic meaning of the text. Points in the text embedding space are organized such that text with similar meanings are located near each other, reflecting the relationships between different words, phrases, or sentences based on contextual usage.

In some cases, an image embedding space is a high-dimensional vector space where each point corresponds to a visual representation of the image. In the image embedding space, the distance between points reflects the similarity of the visual features of the images. In some cases, similar images are located closer to each other based on the characteristics encoded in the image embeddings.

A multimodal embedding is a representation that combines information from different modalities, such as text and image, into a unified embedding space. For example, the multimodal encoder encodes the text and image features into a shared space where the features (or tokens) can interact or be compared directly. For example, the multimodal embedding space (also known as a joint embedding space) is a high-dimensional space where different types of data (modalities), such as text, images, audio, or video, are represented in a unified manner. In the joint embedding space, data from various modalities are encoded into vectors that can be compared and related to each other directly, even though the data originate from different sources. For example, the text embedding of the text description “a cute cat” and the image embedding of the image of a cute cat would be mapped to nearby points in the joint embedding space. In some cases, the joint embedding space includes a shared semantic space configured to capture shared semantic meanings across modalities, where a text input can be matched to an image or vice versa. This joint embedding space enables the machine learning model to understand relationships between words and visual features, leading to enhanced capabilities for multimodal tasks like visual question answering, image captioning, or enhanced image generation.

In some embodiments, the text prompt includes a nonce token. A nonce token is a token used to act as a placeholder in the text prompt (e.g., a sequence of words) where an image token can be placed in the placeholder. The nonce token serves as a multimodal bridging element, allowing interaction between the text tokens (from the text prompt) and image tokens (from the image data).

At operation 715, the system generates, using a mapping encoder, a guidance embedding based on the multimodal embedding, where the guidance embedding represents the first image element and the second image element in a guidance embedding space different from the multimodal embedding space. In some cases, the operations of this step refer to, or may be performed by, a mapping encoder as described with reference to FIGS. 8, 9, 15, and 16. In some cases, the guidance embedding may include a text embedding representing the first image element of the input image and the second image element of the text prompt. In some cases, the guidance embedding may include an image embedding representing the first image element of the input image and the second image element of the text prompt. In some cases, the guidance embedding may include a multimodal embedding representing the first image element of the input image and the second image element of the text prompt.

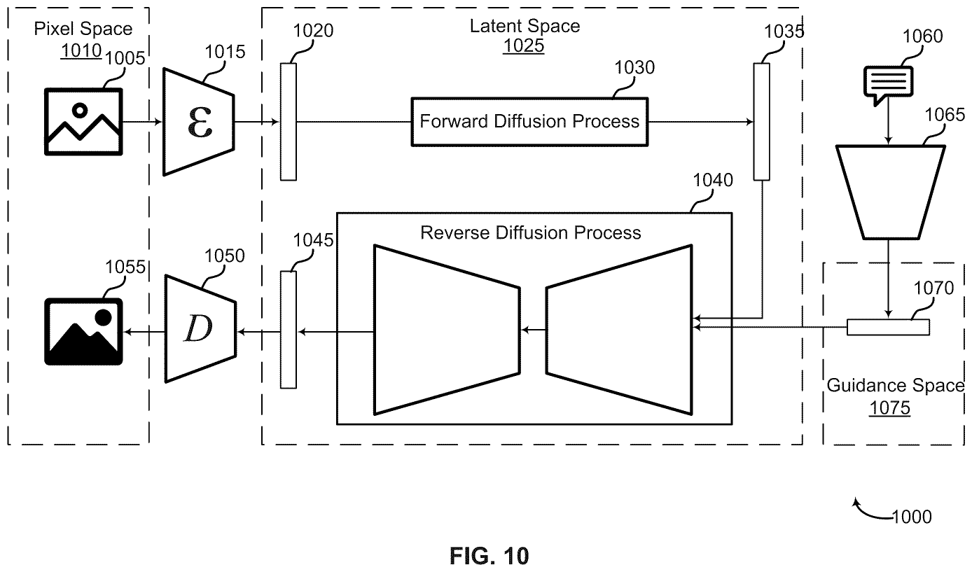

In some cases, the guidance embedding represents the semantic meaning, correlation, and relation between the first image element of the input image and the second image element of the text prompt in a guidance space (e.g., a low-dimensional vector space). In some cases, the guidance embedding can be used to augment the pretrained image generation model to guide the image generation process. Guidance embedding is an example of, or includes aspects of, the guidance feature described with reference to FIG. 10.

At operation 720, the system generates, using an image generation model, a synthetic image based on the guidance embedding, where the synthetic image depicts the first image element and the second image element. In some cases, the operations of this step refer to, or may be performed by, an image generation model as described with reference to FIGS. 8, 9, 15, and 16. For example, the synthetic image includes image pixels generated by the image generation model. In some cases, the synthetic image includes image pixels from the input image and image pixels generated by the image generation model.

### System Architecture

In FIGS. 8-11 and 19, an apparatus and system for image processing include at least one memory component, at least one processing device coupled to the memory component, a mapping encoder comprising parameters stored in the memory component trained to generate a guidance embedding based on a multimodal embedding, where the guidance embedding represents a first image element from an input image and a second image element from a text prompt in a guidance embedding space, and an image generation model comprising parameters stored in the memory component trained to generate a synthetic image based on the guidance embedding, where the synthetic image depicts the first image element and the second image element

Some examples of the apparatus and system further include a multimodal encoder configured to generate a multimodal sequence of tokens including a first token representing the first image element and a second token representing the second image element, where the multimodal embedding is generated based on the multimodal sequence of tokens.

Some examples of the apparatus and system further include an image tokenizer configured to tokenize the input image to obtain the first token. Some examples of the apparatus and system further include a text tokenizer configured to tokenize the text prompt to obtain the second token. In some aspects, the multimodal encoder comprises a transformer architecture. In some aspects, the image generation model comprises a diffusion U-Net architecture.

FIG. 8 shows an example of an image processing apparatus 800 according to aspects of the present disclosure. The example shown includes image processing apparatus 800, processor unit 805, I/O module 810, memory unit 815, and training component 845. In one aspect, memory unit 815 includes multimodal encoder 820, image tokenizer 825, text tokenizer 830, mapping encoder 835, and image generation model 840. In one aspect, multimodal encoder 820 includes image tokenizer 825 and text tokenizer 830.

According to some embodiments of the present disclosure, image processing apparatus 800 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 800 is an example of, or includes aspects of, the corresponding element described with reference to FIG. 1.

Processor unit 805 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 805 is configured to operate a memory array using a memory controller. In other cases, a memory controller is integrated into the processor. In some cases, processor unit 805 is configured to execute computer-readable instructions stored in a memory to perform various functions. In some embodiments, processor unit 805 includes special-purpose components for modem processing, baseband processing, digital signal processing, or transmission processing. Processor unit 805 is an example of, or includes aspects of, the processor described with reference to FIG. 19.

I/O module 810 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 810 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 810 is an example of, or includes aspects of, the I/O interface described with reference to FIG. 19.

Examples of memory unit 815 include random access memory (RAM), read-only memory (ROM), or a hard disk. Examples of memory unit 815 include solid-state memory and a hard disk drive. In some examples, memory unit 815 is used to store computer-readable, computer-executable software including instructions that, when executed, cause a processor to perform various functions described herein.

In some cases, memory unit 815 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 815 store information in the form of a logical state.

In one aspect, memory unit 815 includes a machine learning model. In one aspect, the machine learning model includes multimodal encoder 820, image tokenizer 825, text tokenizer 830, mapping encoder 835, and image generation model 840. Memory unit 815 is an example, of, or includes aspects of, the memory subsystem described with reference to FIG. 19.

In some cases, the machine learning model is a computational algorithm, model, or system designed to recognize patterns, make predictions, or perform a specific task (for example, image processing) without being explicitly programmed. According to some aspects, machine learning model is implemented as software stored in memory unit 815 and executable by processor unit 805, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented CNN. CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of the elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, multimodal encoder 820 is implemented as software stored in memory unit 815 and executable by processor unit 805, as firmware, as one or more hardware circuits, or as a combination thereof. According to some aspects, multimodal encoder 820 obtains an input image and a text prompt, where the input image depicts a first image element and the text prompt describes a second image element. In some examples, multimodal encoder 820 generates a multimodal embedding based on the input image and the text prompt, where the multimodal embedding represents the first image element and the second image element in a multimodal embedding space. In some examples, multimodal encoder 820 generates a multimodal sequence of tokens including the first token and the second token, where the multimodal embedding is generated based on the multimodal sequence of tokens.

According to some aspects, multimodal encoder 820 obtains an additional image depicting a third image element, where the multimodal embedding includes a third token representing the third image element and the synthetic image depicts the third image element. According to some aspects, multimodal encoder 820 generates a multimodal embedding based on the text prompt. In some examples, multimodal encoder 820 obtains a system prompt indicating an image generation task, where the multimodal embedding is generated based on the system prompt.

According to some aspects, multimodal encoder 820 is configured to generate a multimodal sequence of tokens including a first token representing the first image element and a second token representing the second image element, where the multimodal embedding is generated based on the multimodal sequence of tokens. In some aspects, the multimodal encoder 820 includes a transformer architecture. Multimodal encoder 820 is an example of, or includes aspects of, the corresponding element described with reference to FIGS. 9, 15, and 16.

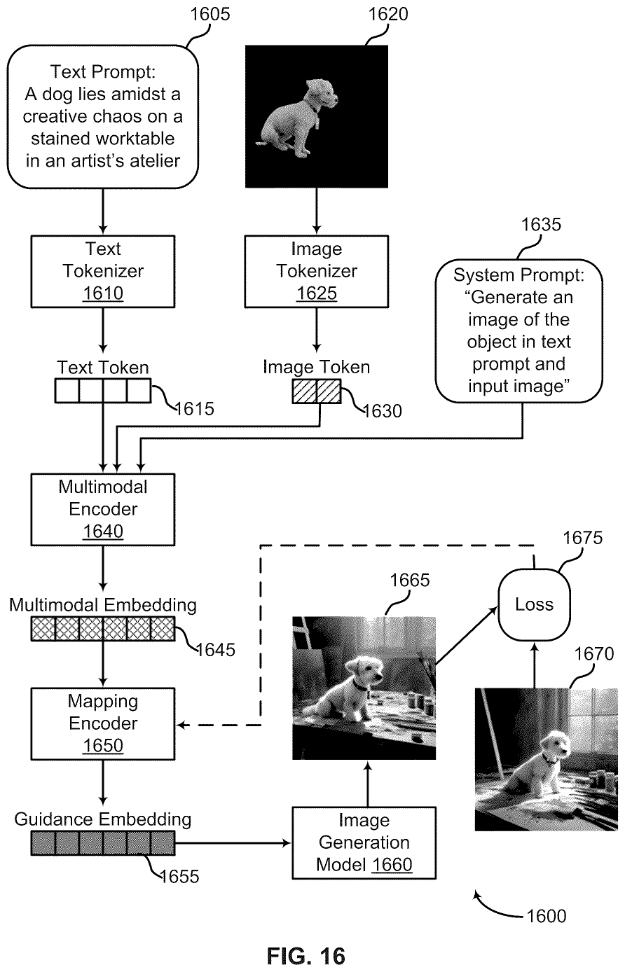

According to some aspects, image tokenizer 825 is implemented as software stored in memory unit 815 and executable by processor unit 805, as firmware, as one or more hardware circuits, or as a combination thereof. According to some aspects, image tokenizer 825 tokenizes the input image to obtain a first token representing the first image element. According to some aspects, image tokenizer 825 is configured to tokenize the input image to obtain the first token. Image tokenizer 825 is an example of, or includes aspects of, the corresponding element described with reference to FIGS. 9 and 16.

According to some aspects, text tokenizer 830 is implemented as software stored in memory unit 815 and executable by processor unit 805, as firmware, as one or more hardware circuits, or as a combination thereof. According to some aspects, text tokenizer 830 tokenizes the text prompt to obtain a second token representing the first image element. In some examples, text tokenizer 830 replaces a nonce token from the text prompt with the first token. According to some aspects, text tokenizer 830 is configured to tokenize the text prompt to obtain the second token. Text tokenizer 830 is an example of, or includes aspects of, the corresponding element described with reference to FIGS. 9, 15, and 16.

According to some aspects, mapping encoder 835 is implemented as software stored in memory unit 815 and executable by processor unit 805, as firmware, as one or more hardware circuits, or as a combination thereof. According to some aspects, mapping encoder 835 generates a guidance embedding based on the multimodal embedding, where the guidance embedding represents the first image element and the second image element in a guidance embedding space different from the multimodal embedding space. In some aspects, the mapping encoder 835 is trained to generate the guidance embedding while the image generation model 840 is frozen.

According to some aspects, mapping encoder 835 generates a predicted guidance embedding based on the multimodal embedding, where the synthetic image is generated based on the predicted guidance embedding. According to some aspects, mapping encoder 835 comprising parameters stored in the memory component trained to generate a guidance embedding based on a multimodal embedding, where the guidance embedding represents a first image element from an input image and a second image element from a text prompt in a guidance embedding space. Mapping encoder 835 is an example of, or includes aspects of, the corresponding element described with reference to FIGS. 9, 15, and 16.

According to some aspects, image generation model 840 is implemented as software stored in memory unit 815 and executable by processor unit 805, as firmware, as one or more hardware circuits, or as a combination thereof. According to some aspects, image generation model 840 generates a synthetic image based on the guidance embedding, where the synthetic image depicts the first image element and the second image element. In some examples, the input image is provided to the image generation model 840 to preserve the identity of the first image element in the synthetic image. In some examples, image generation model 840 obtains a noise input. In some examples, image generation model 840 denoises the noise input based on the guidance embedding to generate the synthetic image.

According to some aspects, the image generation model 840 is trained jointly with the mapping encoder 835. According to some aspects, image generation model 840 generates a synthetic image based on the multimodal embedding. According to some aspects, image generation model 840 comprises parameters stored in the memory component trained to generate a synthetic image based on the guidance embedding, where the synthetic image depicts the first image element and the second image element. In some aspects, the image generation model 840 includes a diffusion U-Net architecture. Image generation model 840 is an example of, or includes aspects of, the corresponding element described with reference to FIGS. 9, 15, and 16.

According to some aspects, image processing apparatus 800 includes a training component 845. The training component 845 is implemented as software stored in memory unit 815 and executable by processor unit 805, as firmware, as one or more hardware circuits, or as a combination thereof. According to some embodiments, the training component 845 is implemented as software stored in a memory unit and executable by a processor in the processor unit of a separate computing device, as firmware in the separate computing device, as one or more hardware circuits of the separate computing device, or as a combination thereof. In some examples, the training component 845 is part of another apparatus other than image processing apparatus 800 and communicates with the image processing apparatus 800. In some examples, training component 845 is part of image processing apparatus 800.

According to some aspects, training component 845 obtains a training set including an image and a text prompt describing the image. In some examples, training component 845 trains, using the training set and the synthetic image, a mapping encoder 835 to generate a guidance embedding for the image generation model 840. In some examples, training component 845 computes a loss based on the image and the synthetic image. In some examples, training component 845 updates parameters of the mapping encoder 835 based on the loss.

According to some aspects, training component 845 freezes the image generation model 840 during a first training stage. In some examples, training component 845 trains the image generation model 840 jointly with the mapping encoder 835 during a second training stage. In some aspects, the training set includes a masked image depicting a first image element from the image, where the multimodal embedding is generated based on the masked image.

FIG. 9 shows an example of a machine learning model according to aspects of the present disclosure. The example shown includes machine learning system 900, text prompt 905, text tokenizer 910, text token 915, input image 920, image tokenizer 925, image token 930, multimodal sequence of tokens 935, multimodal encoder 940, multimodal embedding 945, mapping encoder 950, guidance embedding 955, noise input 960, image generation model 965, and synthetic image 970. In one aspect, the machine learning system 900 includes text tokenizer 910, image tokenizer 925, multimodal encoder 940, mapping encoder 950, and image generation model 965.

Referring to FIG. 9, the machine learning system 900 receives text prompt 905 and input image 920, and generates synthetic image 970. For example, the text tokenizer 910 receives the text prompt 905 and generates a text token 915 (or a sequence of text tokens) that represents one or more image elements (or the second image element) of the text prompt. For example, the text prompt 905 states “A dog lies amidst a creative chaos on a stained worktable in an artist's atelier.” In some cases, the text token 915 is referred to as the second token that represents the second image element of the text prompt. In some cases, each text token of the sequence of text tokens may represent a word or sub-word of the text prompt 905. In some cases, the text prompt 905 includes a nonce token that represents a location of the input image 920 within the text prompt 905. In some cases, for example, the text token 915 includes one hundred tokens.

In some aspects, the image tokenizer 925 receives the input image 920 and generates image token 930. For example, the input image 920 depicts the dog described in the text prompt 905. In some cases, image token 930 is referred to as the first token that represents the first image element of the input image 920. In some cases, image token 930 may include a set of image tokens that represent the image pixels or group of image pixels of the input image 920 or the object (e.g., the dog) depicted in the input image 920. In some cases, for example, the image token 930 include forty tokens.

According to some embodiments, the text token 915 and the image token 930 are combined to obtain the multimodal sequence of tokens 935. For example, the image token 930 is inserted in a location of the sequence in the text token 915 that aligns with the text prompt 905. For example, when the dog is described at the beginning of the text prompt 905, the image token 930 is inserted in a location at the beginning of the sequence of the text token 915. Accordingly, the machine learning system 900 can learn the semantic meaning, correlation, and relation between one or more image elements described by the text prompt 905 and one or more image elements depicted in the input image 920. In some cases, the multimodal sequence of tokens 935 include a hundred forty tokens.

According to some embodiments, the multimodal encoder 940 receives the multimodal sequence of tokens 935 and generates multimodal embedding 945. In some cases, for example, the multimodal encoder includes a multimodal language generation model (M-LLM) configured to receive multimodal inputs having the same or different modalities in different spaces and to generate a representation (e.g., a latent representation) in a joint space (e.g., a multimodal embedding space). For example, the multimodal sequence of tokens 935 may be represented in a combined space of text embedding space (representing the text prompt 905) and image embedding space (representing the input image 920). For example, the multimodal embedding 945 may be represented in a joint embedding space that represents the image element of the text prompt 905 and the image element of the input image 920. In some cases, the multimodal embedding 945 and the multimodal sequence of tokens 935 have the same dimensions.

According to some embodiments, the mapping encoder 950 receives the multimodal embedding 945 and generates the guidance embedding 955. For example, the guidance embedding 955 may include a text embedding, an image embedding, or a multimodal embedding. In some aspects, the mapping encoder 950 converts the multimodal embedding 945 in the joint embedding space to a guidance embedding 955 in a guidance space that can be used to guide the image generation model 965. In some embodiments, when the image generation model 965 is trained to generate images based on text embeddings, the guidance embedding 955 includes a text embedding. In some embodiments, when the image generation model 965 is trained to generate images based on image embeddings, the guidance embedding 955 includes an image embedding. In some embodiments, when the image generation model 965 is trained to generate images based on multimodal embeddings, the guidance embedding 955 includes a multimodal embedding. In some cases, the guidance embedding 955 has fewer dimension than the multimodal embedding 945.

By converting or mapping the multimodal embedding 945 to the guidance embedding 955, the guidance embedding 955 can be processed using a pretrained image generation model. In some cases, the pretrained image generation model can be pretrained using a text embedding, an image embedding, or a multimodal embedding. In some aspects, the mapping encoder 950 includes five layers of bidirectional transformer blocks and maps the tokens (e.g., the multimodal embedding 945) from M-LLM (e.g., the multimodal encoder 940) to a guidance space (e.g., a text space) in the image decoder (e.g., the image generation model 965). For example, the 4096-dimension tokens are mapped to 1024-dimension text tokens.

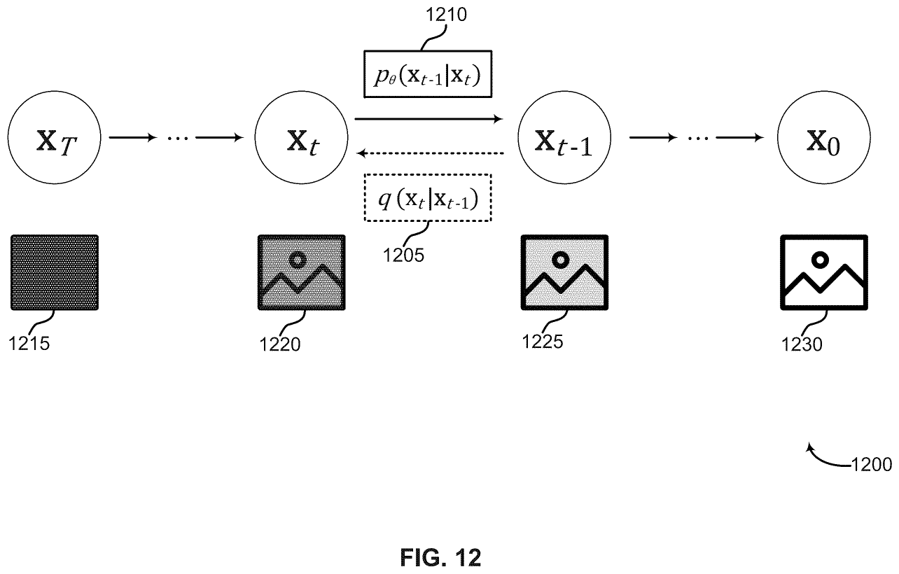

According to some embodiments, the image generation model 965 takes guidance embedding 955 and noise input 960, and generates synthetic image 970. For example, the image generation model 965 takes the noise input 960 to initiate the image generation process (e.g., the reverse diffusion process described with reference to FIGS. 10 and 12). In some cases, the noise input 960 includes random noise. By initiating the image generation model 965 with random noise, variations of the synthetic image 970 can be generated. Then, the guidance embedding 955 is used to guide the reverse diffusion process. For example, the guidance embedding 955 can be combined with the intermediate noisy feature using a cross-attention block within the reverse diffusion process of the U-Net architecture of the image generation model 965. Accordingly, the image generation model 965 generates the synthetic image 970 depicting image features that align with the guidance embedding 955.

In some embodiments, the image generation model 965 includes a diffusion-based U-Net architecture conditioned to model the distribution P(I|X, Y) P(I|X, Y) P(I|X,Y), where I represents the 128×128 RGB image, X∈ [symbol] ¹⁰²⁴ is the ground-truth image embedding, and Y∈ [symbol] ^{128×1024} is the text embedding. In some cases, the training component (described with reference to FIG. 8) trains the model under this configuration for millions of iterations to effectively enable the model to learn to generate images given either text or image as conditions. In some embodiments, the image generation model 965 includes a pretrained diffusion-based image generation model or similar generative models.

According to some embodiments, machine learning system 900 generates the synthetic image 970 with identity preservation. For example, during the image generation process, the image generation model 965 takes the input image 920 as an additional input condition. For example, the input image 920 is combined with the noise input 960 to generate a noisy image. In some cases, the noisy image is used to initiate the reverse diffusion process. As a result, image features of the image element depicted in the input image 920 can be preserved in the synthetic image 970.

According to some embodiments, the machine learning system 900 is able to take multiple input images and a text prompt 905 to generate the synthetic image 970. In some cases, the machine learning system 900 receives an additional input image. The additional input image is input into the image tokenizer 925 to generate an additional image token. The additional image token is combined with the text token 915 and the image token 930 to generate the multimodal sequence of tokens 935. As a result, the machine learning system 900 is able to understand the semantic meaning, correlation, and relation between the text prompt 905, input image 920, and the additional input image to accurately generate the synthetic image 970 that aligns with the image elements from the multiple inputs.

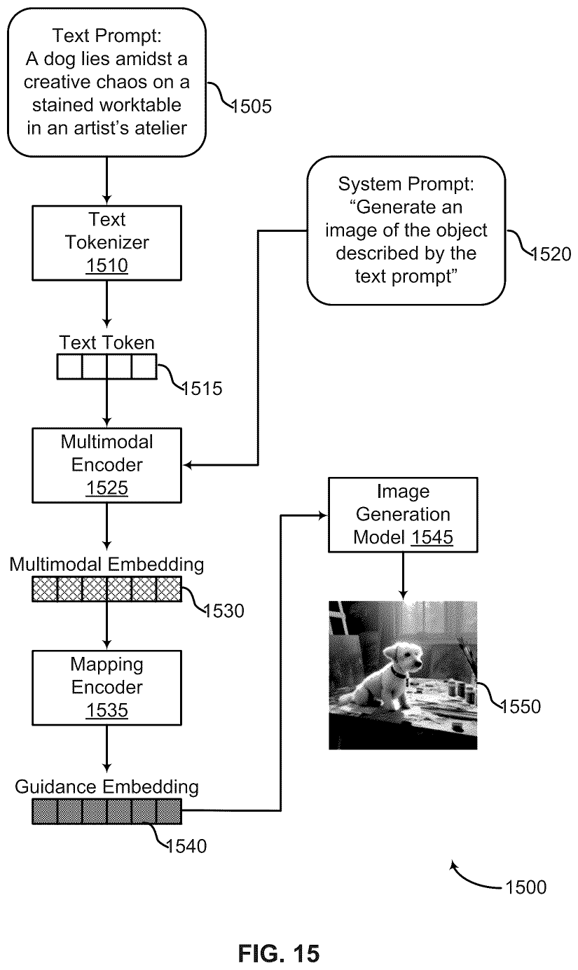

Text prompt 905 is an example of, or includes aspects of, the corresponding element described with reference to FIGS. 3, 6, 6, 10, 15, and 16. Text tokenizer 910 is an example of, or includes aspects of, the corresponding element described with reference to FIGS. 8, 15, and 16. Text token 915 is an example of, or includes aspects of, the corresponding element described with reference to FIGS. 15 and 16. Input image 920 is an example of, or includes aspects of, the corresponding element described with reference to FIGS. 4, 6, and 16.

Image tokenizer 925 is an example of, or includes aspects of, the corresponding element described with reference to FIGS. 8 and 16. Image token 930 is an example of, or includes aspects of, the corresponding element described with reference to FIG. 16. Multimodal encoder 940 is an example of, or includes aspects of, the corresponding element described with reference to FIGS. 8, 15, and 16. Multimodal embedding 945 is an example of, or includes aspects of, the corresponding element described with reference to FIGS. 15 and 16.

Mapping encoder 950 is an example of, or includes aspects of, the corresponding element described with reference to FIGS. 8, 15, and 16. Guidance embedding 955 is an example of, or includes aspects of, the corresponding element described with reference to FIGS. 15 and 16. Image generation model 965 is an example of, or includes aspects of, the corresponding element described with reference to FIGS. 8, 15, and 16. Synthetic image 970 is an example of, or includes aspects of, the corresponding element described with reference to FIGS. 3-6.

FIG. 10 shows an example of an image generation model according to aspects of the present disclosure. The example shown includes diffusion model 1000, original image 1005, pixel space 1010, image encoder 1015, original image feature 1020, latent space 1025, forward diffusion process 1030, noisy feature 1035, reverse diffusion process 1040, denoised image feature 1045, image decoder 1050, output image 1055, text prompt 1060, text encoder 1065, guidance feature 1070, and guidance space 1075. In some aspects, diffusion model 1000 is an example of, or includes aspects of, the image generation model described with reference to FIGS. 8, 9, 15, and 16.

Diffusion models are a class of generative neural networks that can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance, color guidance, style guidance, and image guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (e.g., latent diffusion).

Diffusion models work by iteratively adding noise to the data during a forward process and then learning to recover the data by denoising the data during a reverse process. For example, during training, diffusion model 1000 may take an original image 1005 in a pixel space 1010 as input and apply an image encoder 1015 to convert original image 1005 into original image feature 1020 in a latent space 1025. Then, a forward diffusion process 1030 gradually adds noise to the original image feature 1020 to obtain noisy feature 1035 (also in latent space 1025) at various noise levels.

Next, a reverse diffusion process 1040 (e.g., a U-Net ANN) gradually removes the noise from the noisy feature 1035 at the various noise levels to obtain the denoised image feature 1045 in latent space 1025. In some examples, denoised image feature 1045 is compared to the original image feature 1020 at each of the various noise levels, and parameters of the reverse diffusion process 1040 of the diffusion model are updated based on the comparison. Then, an image decoder 1050 decodes the denoised image feature 1045 to obtain an output image 1055 in pixel space 1010. In some cases, an output image 1055 is created at each of the various noise levels. The output image 1055 can be compared to the original image 1005 to train the reverse diffusion process 1040. In some cases, output image 1055 refers to the synthetic image (e.g., described with reference to FIGS. 3-6 and 9).

In some cases, image encoder 1015 and image decoder 1050 are pre-trained prior to training the reverse diffusion process 1040. In some examples, image encoder 1015 and image decoder 1050 are trained jointly, or the image encoder 1015 and image decoder 1050 are fine-tuned jointly with the reverse diffusion process 1040.

The reverse diffusion process 1040 can also be guided based on a text prompt 1060, or another guidance prompt, such as an image, a layout, a style, a color, a segmentation map, etc. The text prompt 1060 can be encoded using a text encoder 1065 (e.g., a multimodal encoder) to obtain guidance feature 1070 in guidance space 1075. The guidance feature 1070 can be combined with the noisy feature 1035 at one or more layers of the reverse diffusion process 1040 to ensure that the output image 1055 includes content described by the text prompt 1060. For example, guidance feature 1070 can be combined with the noisy feature 1035 using a cross-attention block within the reverse diffusion process 1040. In some aspects, guidance feature 1070 is an example of, or includes aspects of, the guidance embedding described with reference to FIGS. 9 and 15-16. In some cases, the guidance space 1075 refers to the guidance embedding space.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing the machine learning model to understand the context and generate more accurate and contextually relevant outputs.

In some examples, diffusion models are based on a neural network architecture known as a U-Net. The U-Net takes input features having an initial resolution and an initial number of channels, and processes the input features using an initial neural network layer (e.g., a convolutional network layer) to generate intermediate features. The intermediate features are then down-sampled using a down-sampling layer such that down-sampled features have a resolution less than the initial resolution and a number of channels greater than the initial number of channels.

This process is repeated multiple times, and then the process is reversed. For example, the down-sampled features are up-sampled using the up-sampling process to obtain up-sampled features. The up-sampled features can be combined with intermediate features having a same resolution and number of channels via a skip connection. These inputs are processed using a final neural network layer to produce output features. In some cases, the output features have the same resolution as the initial resolution and the same number of channels as the initial number of channels.

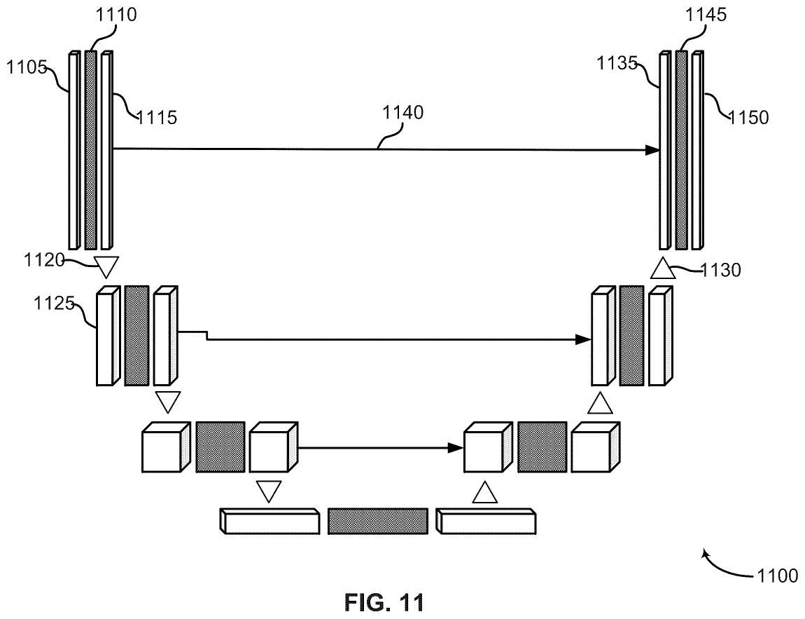

In some cases, a U-Net takes additional input features to produce conditionally generated output. For example, the additional input features may include a vector representation of an input prompt. The additional input features can be combined with the intermediate features within the neural network at one or more layers. For example, a cross-attention module can be used to combine the additional input features and the intermediate features. Further detail on the U-Net is described with reference to FIG. 11.

A diffusion process may also be modified based on conditional guidance. In some cases, a user provides a text prompt (e.g., text prompt 1060) describing content to be included in a generated image. In some examples, guidance can be provided in a form other than text, such as via an image, a sketch, a color, a style, or a layout. The system converts text prompt 1060 (and/or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

A noise map is initialized that includes random noise. The noise map may be in a pixel space or a latent space. By initializing an image with random noise, different variations of an image including the content described by the conditional guidance can be generated. Then, the diffusion model 1000 generates an image based on the noise map and the conditional guidance vector.

A diffusion process can include both a forward diffusion process 1030 for adding noise to an image (e.g., original image 1005) or features (e.g., original image feature 1020) in a latent space 1025 and a reverse diffusion process 1040 for denoising the images (or features) to obtain a denoised image (e.g., output image 1055). The forward diffusion process 1030 can be represented as q(xₜ|xₜ₋₁), and the reverse diffusion process 1040 can be represented as p_{θ}(xₜ₋₁|xₜ). Further detail on the diffusion process is described with reference to FIG. 12.

A diffusion model 1000 may be trained using both a forward diffusion process 1030 and a reverse diffusion process 1040. In one example, the user initializes an untrained model. Initialization can include defining the architecture of the model and establishing initial values for the model parameters. In some cases, the initialization can include defining hyper-parameters such as the number of layers, the resolution and channels of each layer block, the location of skip connections, and the like.

The system then adds noise to a training image using a forward diffusion process 1030 in N stages. In some cases, the forward diffusion process 1030 is a fixed process where Gaussian noise is successively added to an image. In latent diffusion models, the Gaussian noise may be successively added to features (e.g., original image feature 1020) in a latent space 1025.

At each stage n, starting with stage N, a reverse diffusion process 1040 is used to predict the image or image features at stage n−1. For example, the reverse diffusion process 1040 can predict the noise that was added by the forward diffusion process 1030, and the predicted noise can be removed from the image to obtain the predicted image. In some cases, an original image 1005 is predicted at each stage of the training process.

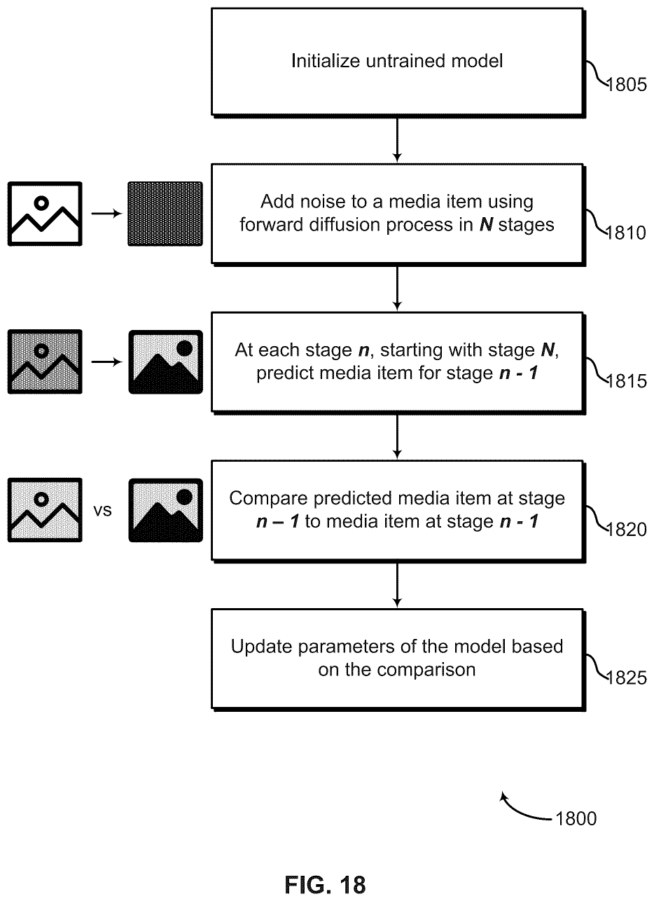

The training component (e.g., training component described with reference to FIG. 8) compares predicted image (or image features) at stage n−1 to an actual image (or image features), such as the image at stage n−1 or the original input image. For example, given observed data x, the diffusion model 1000 may be trained to minimize the variational upper bound of the negative log-likelihood −log p_{θ}(x) of the training data. The training component then updates parameters of the diffusion model 1000 based on the comparison. For example, parameters of a U-Net may be updated using gradient descent. Time-dependent parameters of the Gaussian transitions can also be learned. Further detail on training the diffusion model is described with reference to FIG. 18.

Original image 1005 is an example of, or includes aspects of, the corresponding element described with reference to FIG. 12. Forward diffusion process 1030 is an example of, or includes aspects of, the corresponding element described with reference to FIG. 12. Reverse diffusion process 1040 is an example of, or includes aspects of, the corresponding element described with reference to FIG. 12. Text prompt 1060 is an example of, or includes aspects of, the corresponding element described with reference to FIGS. 3, 6, 6, 9, 15, and 16.

FIG. 11 shows an example of a U-Net 1100 architecture according to aspects of the present disclosure. The example shown includes U-Net 1100, input feature 1105, initial neural network layer 1110, intermediate feature 1115, down-sampling layer 1120, down-sampled feature 1125, up-sampling process 1130, up-sampled feature 1135, skip connection 1140, final neural network layer 1145, and output feature 1150.

In some examples, U-Net 1100 is an example of the component that performs the reverse diffusion process 1040 of diffusion model 1000 described with reference to FIG. 10 and includes architectural elements of the image generation model 840 described with reference to FIG. 8. The U-Net 1100 depicted in FIG. 11 is an example of, or includes aspects of, the architecture used within the reverse diffusion process described with reference to FIG. 10.

In some examples, diffusion models are based on a neural network architecture known as a U-Net. The U-Net 1100 takes input feature 1105 having an initial resolution and an initial number of channels, and processes the input feature 1105 using an initial neural network layer 1110 (e.g., a convolutional network layer) to produce intermediate feature 1115. The intermediate feature 1115 is then down-sampled using a down-sampling layer 1120 such that the down-sampled feature 1125 has a resolution less than the initial resolution and a number of channels greater than the initial number of channels.

This process is repeated multiple times, and then the process is reversed. For example, the down-sampled feature 1125 is up-sampled using up-sampling process 1130 to obtain up-sampled feature 1135. The up-sampled feature 1135 can be combined with intermediate feature 1115 having the same resolution and number of channels via a skip connection 1140. These inputs are processed using a final neural network layer 1145 to produce output feature 1150. In some cases, the output feature 1150 has the same resolution as the initial resolution and the same number of channels as the initial number of channels.

In some cases, U-Net 1100 takes an additional input feature to produce conditionally generated output. For example, the additional input feature could include a vector representation of an input prompt. The additional input feature can be combined with the intermediate feature 1115 within the neural network at one or more layers. For example, a cross-attention module can be used to combine the additional input features and the intermediate feature 1115.

### Diffusion Process

FIG. 12 shows an example of a diffusion process 1200 according to aspects of the present disclosure. The example shown includes diffusion process 1200, forward diffusion process 1205, reverse diffusion process 1210, noisy image 1215, first intermediate image 1220, second intermediate image 1225, and original image 1230.

Diffusion process 1200 can include forward diffusion process 1205 for adding noise to original image 1230 (e.g., original image 1005 described with reference to FIG. 10) or features (e.g., original image feature 1020 described with reference to FIG. 10) in a latent space. In some aspects, diffusion process 1200 includes reverse diffusion process 1210 for denoising the noisy image 1215 (or image features) to obtain a denoised image (or original image 1230). The forward diffusion process 1205 can be represented as q(xₜ|xₜ₋₁), and the reverse diffusion process 1210 can be represented as p_{θ}(xₜ₋₁|xₜ). In some cases, the forward diffusion process 1205 is used during training to generate images with successively greater noise, and a neural network is trained to perform the reverse diffusion process 1210 (e.g., to successively remove the noise).

In an example forward diffusion process 1205 for a latent diffusion model (e.g., diffusion model 1000 described with reference to FIG. 10), the diffusion model maps an observed variable x₀ (either in a pixel space or a latent space) to obtain intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse diffusion process 1210. During the reverse diffusion process 1210, the diffusion model begins with noisy data x₇, such as a noisy image 1215 and denoises the data to obtain the p_{θ}(xₜ₋₁|x₂). At each step t−1, the reverse diffusion process 1210 takes xₜ, such as the first intermediate image 1220, and t as input. Here, t represents a step in the sequence of transitions associated with different noise levels, The reverse diffusion process 1210 outputs xₜ₋₁, such as the second intermediate image 1225, iteratively until x_{T} is reverted back to x₀, the original image 1230. The reverse diffusion process 1210 can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} \text{:} {p}_{θ} ( {x}_{0 : T} ) : = p ( {x}_{T} ) {Π}_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse diffusion process 1210 takes the outcome of the forward diffusion process 1205, a sample of pure noise, as input and

$${Π}_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Forward diffusion process 1205 is an example of, or includes aspects of, the corresponding element described with reference to FIG. 10. Reverse diffusion process 1210 is an example of, or includes aspects of, the corresponding element described with reference to FIG. 10. Original image 1230 is an example of, or includes aspects of, the corresponding element described with reference to FIG. 10.

### Sequence Token Generation

FIG. 13 shows an example of a method 1300 for combining the image token and the text token according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the system tokenizes the input image to obtain a first token representing the first image element. In some cases, the operations of this step refer to, or may be performed by, an image tokenizer as described with reference to FIGS. 8, 9, and 16. In some cases, the first token may represent one or more image elements depicted by the input image. In some cases, the first token may be referred to as the image token(s). In some cases, an image is often split into smaller parts, such as patches (or image tokens). These image tokens are numerical representations of small segments of the image, like pixels or groups of pixels, which are then processed by the model.

At operation 1310, the system tokenizes the text prompt to obtain a second token representing the first image element. In some cases, the operations of this step refer to, or may be performed by, a text tokenizer as described with reference to FIGS. 8, 9, 15, and 16. In some cases, the second token may represent one or more image elements described by the text prompt. In some cases, the second token may be referred to as the text token(s). In some cases, the text token represents an individual unit of the text prompt which is broken down into words, sub-words, or even characters. Each token represents a part of the text, such as “dog” or “d”, “o”, “g” based on the tokenization method.

At operation 1315, the system generates a multimodal sequence of tokens including the first token and the second token, where the multimodal embedding is generated based on the multimodal sequence of tokens. In some cases, the operations of this step refer to, or may be performed by, a multimodal encoder as described with reference to FIGS. 8, 9, 15, and 16. In some cases, for example, the image token is inserted in a location of the sequence in the text token that aligns with the text prompt. Accordingly, the system can learn the semantic meaning, correlation, and relation between one or more image elements described by the text prompt and one or more image elements depicted in the input image.

### Training and Evaluation

In FIGS. 14-18, a method, apparatus, non-transitory computer readable medium, and system for training a machine learning model include obtaining a training set including an image and a text prompt describing the image, generating a multimodal embedding based on the text prompt, generating, using an image generation model, a synthetic image based on the multimodal embedding, and training, using the training set and the synthetic image, a mapping encoder to generate a guidance embedding for the image generation model.

Some examples of the method, apparatus, non-transitory computer readable medium, and system further include obtaining a system prompt indicating an image generation task, where the multimodal embedding is generated based on the system prompt. Some examples of the method, apparatus, non-transitory computer readable medium, and system further include generating a predicted guidance embedding based on the multimodal embedding, where the synthetic image is generated based on the predicted guidance embedding.

Some examples of the method, apparatus, non-transitory computer readable medium, and system further include computing a loss based on the image and the synthetic image. Some examples further include updating parameters of the mapping encoder based on the loss. Some examples of the method, apparatus, non-transitory computer readable medium, and system further include freezing the image generation model during a first training stage. Some examples further include training the image generation model jointly with the mapping encoder during a second training stage. In some aspects, the training set includes a masked image depicting a first image element from the image, where the multimodal embedding is generated based on the masked image.

FIG. 14 shows an example of a method 1400 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the system obtains a training set including an image and a text prompt describing the image. In some cases, the operations of this step refer to, or may be performed by, a training component as described with reference to FIG. 8. In some cases, the training dataset is stored in a database described with reference to FIG. 1.

At operation 1410, the system generates a multimodal embedding based on the text prompt. In some cases, the operations of this step refer to, or may be performed by, a multimodal encoder as described with reference to FIGS. 8, 9, 15, and 16. In some cases, the multimodal encoder receives a text token of the text prompt to generate the multimodal embedding. In some cases, the multimodal embedding is in a joint embedding space. In some cases, the multimodal embedding represents one or more image elements described by the text prompt. In some cases, the operations of this step may be the first training stage described with reference to FIG. 15.

At operation 1415, the system generates, using an image generation model, a synthetic image based on the multimodal embedding. In some cases, the operations of this step refer to, or may be performed by, an image generation model as described with reference to FIGS. 8, 9, 15, and 16. In some cases, the synthetic image depicts one or more image elements described by the text prompt.

At operation 1420, the system trains, using the training set and the synthetic image, a mapping encoder to generate a guidance embedding for the image generation model. In some cases, the operations of this step refer to, or may be performed by, a training component as described with reference to FIG. 8. In some cases, the operations of this step may be the first training stage described with reference to FIG. 15. In some cases, the guidance embedding may be in a guidance space that enables the image generation model to perform the denoising process using the guidance embedding as guidance.

FIG. 15 shows an example of a first training stage according to aspects of the present disclosure. The example shown includes training system 1500, text prompt 1505, text tokenizer 1510, text token 1515, system prompt 1520, multimodal encoder 1525, multimodal embedding 1530, mapping encoder 1535, guidance embedding 1540, image generation model 1545, and training image 1550.

According to some embodiments, the system of the present disclosure is trained using a two-stage training paradigm. In some cases, the system is trained on a single-object-centric training dataset, instead of a multi-object training dataset. As a result, the training cost can be reduced. In some aspects, the multimodal encoder (e.g., the M-LLM) is frozen during the two training stages, thus further reducing the training cost. By training the system using the two-stage training paradigm, system finetuning might not be performed for content generation. In some aspects, the training component trains the mapping encoder to learn the mapping process of converting the multimodal embedding in a multimodal embedding space into a guidance embedding in a guidance embedding space during the first training stage. In some aspects, the training component trains the mapping encoder and the image generation model to accurately generate a synthetic image based on the guidance embedding.

Referring to FIG. 15, the training system 1500 receives the text prompt 1505 and a system prompt 1520, and generates training image 1550. For example, the text tokenizer 1510 receives the text prompt 1505 to generate a text token 1515. For example, the text prompt states “A dog lies amidst a creative chaos on a stained worktable in an artist's atelier.” For example, the text token 1515 represents one or more image elements described by the text prompt 1505.

In some embodiments, the multimodal encoder 1525 receives the text token 1515 and the system prompt 1520, and generates the multimodal embedding 1530 representing the image elements described by the text prompt 1505 and an element instructed by the system prompt 1520. For example, the system prompt 1520 may state “Generate an image of the object described by the text prompt.” In some cases, the text tokenizer 1510 tokenizes the system prompt 1520 to generate an additional text token. In some cases, the text token 1515 and the additional text token are combined and input into the multimodal encoder 1525 to generate the multimodal embedding 1530. As a result, the multimodal encoder 1525 is able to generate an embedding including information or instruction to perform an image generation task.

In some embodiments, the mapping encoder 1535 is trained to receive the multimodal embedding 1530 and generate the guidance embedding 1540 based on the multimodal embedding 1530. In some cases, the mapping encoder 1535 is trained to convert the multimodal embedding 1530 in a multimodal embedding space to a guidance embedding 1540 in a guidance embedding space. In some cases, the guidance embedding space is different from the multimodal embedding space. In some cases, the guidance embedding space includes a text embedding space, an image embedding space, or a combination thereof. In some cases, the guidance embedding 1540 includes a text embedding, image embedding, or multimodal embedding representing the image element described by the text prompt 1505 and information for image generation task. In some embodiments, the image generation model 1545 is configured to generate the training image 1550 based on the guidance embedding 1540.

In some aspects, the multimodal encoder 1525 is able to generate multi-concept token features, but the feature space of multimodal encoder 1525 and the feature space of the image decoder (e.g., the image generation model 1545) might not be aligned. Thus, the mapping encoder 1535 is used between multimodal encoder 1525 and image generation model 1545. In some cases, for example, the backbone architecture of the multimodal encoder 1525 has a maximum of 4 k tokens and has 4096 dimensions, the mapping encoder 1535 is trained to map these tokens (e.g., the text token 1515) to 1024 dimensions without reducing the number of tokens that the multimodal encoder 1525 generates. In some aspects, the mapping encoder 1535 is trained with text tokens. In some cases, the text token 1515 has fewer than, for example, one hundred tokens.

Training system 1500 is an example of, or includes aspects of, the corresponding element described with reference to FIG. 16. Text prompt 1505 is an example of, or includes aspects of, the corresponding element described with reference to FIGS. 3, 6, 6, 9, 10, and 16. Text tokenizer 1510 is an example of, or includes aspects of, the corresponding element described with reference to FIGS. 8, 9, and 16. Text token 1515 is an example of, or includes aspects of, the corresponding element described with reference to FIGS. 9 and 16.

System prompt 1520 is an example of, or includes aspects of, the corresponding element described with reference to FIG. 16. Multimodal encoder 1525 is an example of, or includes aspects of, the corresponding element described with reference to FIGS. 8, 9, and 16. Multimodal embedding 1530 is an example of, or includes aspects of, the corresponding element described with reference to FIGS. 9 and 16. Mapping encoder 1535 is an example of, or includes aspects of, the corresponding element described with reference to FIGS. 8, 9, and 16.

Guidance embedding 1540 is an example of, or includes aspects of, the corresponding element described with reference to FIGS. 9 and 16. Image generation model 1545 is an example of, or includes aspects of, the corresponding element described with reference to FIGS. 8, 9, and 16. Training image 1550 is an example of, or includes aspects of, the corresponding element described with reference to FIG. 16.

FIG. 16 shows an example of a second training stage according to aspects of the present disclosure. The example shown includes training system 1600, text prompt 1605, text tokenizer 1610, text token 1615, input image 1620, image tokenizer 1625, image token 1630, system prompt 1635, multimodal encoder 1640, multimodal embedding 1645, mapping encoder 1650, guidance embedding 1655, image generation model 1660, training image 1665, ground-truth image 1670, and loss 1675.

Referring to FIG. 16, the training system 1600 jointly trains the mapping encoder 1650 and the image generation model 1660 during the second training stage. For example, the text tokenizer 1610 takes the text prompt 1605 and generates text token 1615 representing one or more image elements described by the text prompt 1605. For example, the image tokenizer 1625 receives input image 1620 and generates image token 1630 representing one or more image elements depicted in the input image 1620. In some cases, the multimodal encoder 1640 receives the text token 1615, the image token 1630, and the system prompt 1635, and generates multimodal embedding 1645. In some aspects, the multimodal embedding 1645 represents the image elements from the text prompt 1605, input image 1620, and system prompt 1635 in a multimodal embedding space.

According to some embodiments, the mapping encoder 1650 generates guidance embedding 1655 based on the multimodal embedding 1645, where the guidance embedding 1655 is in a guidance embedding space different than the multimodal embedding space of the multimodal embedding 1645. Then, the image generation model 1660 generates training image 1665 based on the guidance embedding 1655. In some embodiment, the training component takes the training image 1665 and the ground-truth image 1670 to generate the loss 1675. In some embodiments, the loss 1675 is used to train and update parameters of the mapping encoder 1650. In some embodiments, the loss is used to train and update parameters of the image generation model 1660.

Training system 1600 is an example of, or includes aspects of, the corresponding element described with reference to FIG. 15. Text prompt 1605 is an example of, or includes aspects of, the corresponding element described with reference to FIGS. 3, 6, 6, 9, 10, and 15. Text tokenizer 1610 is an example of, or includes aspects of, the corresponding element described with reference to FIGS. 8, 9, and 15.

Text token 1615 is an example of, or includes aspects of, the corresponding element described with reference to FIGS. 9 and 15. Input image 1620 is an example of, or includes aspects of, the corresponding element described with reference to FIGS. 4, 6, and 9. Image tokenizer 1625 is an example of, or includes aspects of, the corresponding element described with reference to FIGS. 8 and 9. Image token 1630 is an example of, or includes aspects of, the corresponding element described with reference to FIG. 9.

System prompt 1635 is an example of, or includes aspects of, the corresponding element described with reference to FIG. 15. Multimodal encoder 1640 is an example of, or includes aspects of, the corresponding element described with reference to FIGS. 8, 9, and 15. Multimodal embedding 1645 is an example of, or includes aspects of, the corresponding element described with reference to FIGS. 9 and 15.

Mapping encoder 1650 is an example of, or includes aspects of, the corresponding element described with reference to FIGS. 8, 9, and 15. Guidance embedding 1655 is an example of, or includes aspects of, the corresponding element described with reference to FIGS. 9 and 15. Image generation model 1660 is an example of, or includes aspects of, the corresponding element described with reference to FIGS. 8, 9, and 15. Training image 1665 is an example of, or includes aspects of, the corresponding element described with reference to FIG. 15.

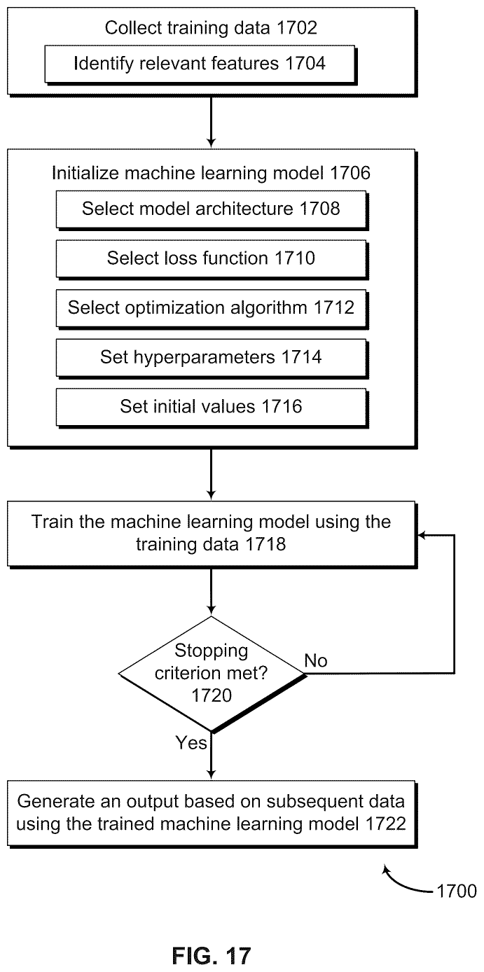

FIG. 17 shows an example of a flow diagram depicting an algorithm as a step-by-step procedure in an example implementation of operations performable for training a machine learning model according to aspects of the present disclosure. In some embodiments, the procedure 1700 describes an operation of the training component described for configuring the image generation model 840 as described with reference to FIG. 8. The procedure 1700 provides one or more examples of generating training data, use of the training data to train a machine-learning model, and use of the trained machine-learning model to perform a task.

To begin in this example, a machine-learning system collects training data (block 1702) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1704) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1706). Initialization of the machine-learning model includes selecting a model architecture (block 1708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1710). The loss function is utilized to measure a difference between an output of the machine-learning model (e.g., the model predictions) and target values (e.g., as expressed by the training data) to be used to train the machine-learning model. Additionally, an optimization algorithm is selected (block 1712) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1716) examples of which include initializing weights and biases of nodes to increase efficiency in training and computational resources consumption as part of training. Hyperparameters are also set (block 1714) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1718) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1720), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1720), procedure 1700 continues the training of the machine-learning model using the training data (block 1718) in this example.

If the stopping criterion is met (“yes” from decision block 1720), the trained machine-learning model is then utilized to generate an output based on subsequent data (block 1722). The trained machine-learning model, for instance, is trained to perform a task as described above and therefore once trained is configured to perform that task based on subsequent data received as an input and processed by the machine-learning model.

FIG. 18 shows an example of a method 1800 for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1800 describes an operation of the training component described for training the image generation model 840 as described with reference to FIG. 8. The method 1800 represents an example for training a reverse diffusion process as described above with reference to FIG. 12. In some examples, these operations are performed by a system including a processor executing a set of codes to control functional elements of an apparatus, such as the image generation model described in FIG. 8.

At operation 1805, the system initializes untrained model. In some cases, the operations of this step refer to, or may be performed by, a training component as described with reference to FIG. 8. Initialization can include defining the architecture of the model and establishing initial values for the model parameters. In some cases, the initialization can include defining hyper-parameters such as the number of layers, the resolution and channels of each layer block, the location of skip connections, and the like.

At operation 1810, the system adds noise to media item using forward diffusion process in N stages. In some cases, the operations of this step refer to, or may be performed by, a training component as described with reference to FIG. 8. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1815, the system at each stage n, starting with stage N, predict media item for stage n−1. In some cases, the operations of this step refer to, or may be performed by, a training component as described with reference to FIG. 8. In some cases, the media item is a synthetic image generated using the image generation model. For example, the reverse diffusion process can predict the noise that was added by the forward diffusion process, and the predicted noise can be removed from the noise input to obtain the predicted output. In some cases, an original media item is predicted at each stage of the training process.

At operation 1820, the system compares the predicted media item (or feature) at stage n−1 to media at stage n−1. In some cases, for example, the system compares the synthetic image (or predicted image feature) at state n−1 to the ground-truth image (or ground-truth feature) at state n−1. In some cases, the operations of this step refer to, or may be performed by, a training component as described with reference to FIG. 8. For example, given observed data x, the diffusion model may be trained to minimize the variational upper bound of the negative log-likelihood −log p_{θ}(x) of the training data.

At operation 1825, the system updates parameters of the model based on the comparison. In some cases, the operations of this step refer to, or may be performed by, a training component as described with reference to FIG. 8. For example, parameters of a U-Net may be updated using gradient descent. Time-dependent parameters of the Gaussian transitions can also be learned.

### Computing Device

FIG. 19 shows an example of a computing device 1900 according to aspects of the present disclosure. The example shown includes computing device 1900, processor 1905, memory subsystem 1910, communication interface 1915, I/O interface 1920, user interface component 1925, and channel 1930.

In some embodiments, computing device 1900 is an example of, or includes aspects of, the image processing apparatus described with reference to FIGS. 1 and 8. In some embodiments, computing device 1900 includes processor 1905 that can execute instructions stored in memory subsystem 1910 to obtain an input image and a text prompt, generate a multimodal embedding based on the input image and the text prompt, generate a guidance embedding based on the multimodal embedding, and generate a synthetic image based on the guidance embedding.

According to some embodiments, processor 1905 includes one or more processors. In some cases, processor 1905 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1905 is configured to operate a memory array using a memory controller. In other cases, a memory controller is integrated into processor 1905. In some cases, processor 1905 is configured to execute computer-readable instructions stored in a memory to perform various functions. In some embodiments, processor 1905 includes special-purpose components for modem processing, baseband processing, digital signal processing, or transmission processing. Processor 1905 is an example of, or includes aspects of, the processor unit described with reference to FIG. 8.

According to some embodiments, memory subsystem 1910 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1910 is an example of, or includes aspects of, the memory unit described with reference to FIG. 8.

According to some embodiments, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1915.

According to some embodiments, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or hardware components controlled by the I/O controller. I/O interface 1920 is an example of, or includes aspects of, the I/O module described with reference to FIG. 8.

According to some embodiments, user interface component 1925 enables a user to interact with computing device 1900. In some cases, user interface component 1925 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3-6.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and a text prompt, wherein the input image depicts a first image element and the text prompt describes a second image element;
generating a multimodal embedding based on the input image and the text prompt, wherein the multimodal embedding represents the first image element and the second image element in a multimodal embedding space;
generating, using a mapping encoder, a guidance embedding based on the multimodal embedding, wherein the guidance embedding represents the first image element and the second image element in a guidance embedding space different from the multimodal embedding space; and
generating, using an image generation model, a synthetic image based on the guidance embedding, wherein the synthetic image depicts the first image element and the second image element.

2. The method of claim 1, wherein generating the multimodal embedding comprises:
tokenizing the input image to obtain a first token representing the first image element;
tokenizing the text prompt to obtain a second token representing the second image element; and
generating a multimodal sequence of tokens including the first token and the second token, wherein the multimodal embedding is generated based on the multimodal sequence of tokens.

3. The method of claim 2, wherein generating the multimodal sequence of tokens comprises:
replacing a nonce token from the text prompt with the first token.

4. The method of claim 1, further comprising:
obtaining an additional image depicting a third image element, wherein the multimodal embedding includes a third token representing the third image element and the synthetic image depicts the third image element.

5. The method of claim 1, wherein generating the synthetic image comprises:
providing the input image to the image generation model to preserve an identity of the first image element in the synthetic image.

6. The method of claim 1, wherein generating the synthetic image comprises:
obtaining a noise input; and
denoising the noise input based on the guidance embedding to generate the synthetic image.

7. The method of claim 1, wherein:
the mapping encoder is trained to generate the guidance embedding while the image generation model is frozen.

8. The method of claim 1, wherein:
the image generation model is trained jointly with the mapping encoder.

9. A non-transitory computer readable medium storing code for image processing, the code comprising instructions that, when executed by at least one processor, cause the at least one processor to perform operations comprising:
obtaining an input image and a text prompt;
generating a multimodal sequence of tokens based on the input image and the text prompt;
generating, using a multimodal encoder, a multimodal embedding based on the multimodal sequence of tokens;
generating, using a mapping encoder, a guidance embedding based on the multimodal embedding; and
generating, using an image generation model, a synthetic image based on the guidance embedding.

10. The non-transitory computer readable medium of claim 9, wherein generating the multimodal sequence of tokens comprises:
tokenizing the input image to obtain a first token;
tokenizing the text prompt to obtain a second token; and
generating the multimodal sequence of tokens including the first token and the second token.

11. The non-transitory computer readable medium of claim 10, wherein generating the multimodal sequence of tokens comprises:
replacing a nonce token from the text prompt with the first token.

12. The method of claim 1, wherein:
the mapping encoder is trained to generate the guidance embedding while the image generation model is frozen.

13. The non-transitory computer readable medium of claim 9, wherein generating the synthetic image comprises:
providing the input image to the image generation model.

14. The non-transitory computer readable medium of claim 9, wherein generating the synthetic image comprises:
obtaining a noise input; and
denoising the noise input based on the guidance embedding to generate the synthetic image.

15. An apparatus comprising:
at least one memory component;
at least one processing device coupled to the at least one memory component;
a mapping encoder comprising parameters stored in the at least one memory component trained to generate a guidance embedding based on a multimodal embedding, wherein the guidance embedding represents a first image element from an input image and a second image element from a text prompt in a guidance embedding space; and
an image generation model comprising parameters stored in the at least one memory component trained to generate a synthetic image based on the guidance embedding, wherein the synthetic image depicts the first image element and the second image element.

16. The apparatus of claim 15, further comprising:
a multimodal encoder configured to generate multimodal sequence of tokens including a first token representing the first image element and a second token representing the second image element, wherein the multimodal embedding is generated based on the multimodal sequence of tokens.

17. The apparatus of claim 16, further comprising:
an image tokenizer configured to tokenize the input image to obtain the first token.

18. The apparatus of claim 16, further comprising:
a text tokenizer configured to tokenize the text prompt to obtain the second token.

19. The apparatus of claim 16, wherein:
the multimodal encoder comprises a transformer architecture.

20. The apparatus of claim 15, wherein:
the image generation model comprises a diffusion U-Net architecture.
